(19) United States
(12) Patent Application Publication
(10) Pub. No.: US 2022/0225428 A1
(43) Pub. Date: Jul. 14, 2022

(54) RESPONSES TO MESSAGE B IN TWO STEP RANDOM ACCESS CHANNEL PROCEDURE

(71) Applicant: Apple Inc., Cupertino, CA (US)

(72) Inventors: Gang XIONG, Cupertino, CA (US); Seau S. LIM, Cupertino, CA (US); Yushu ZHANG, Cupertino, CA (US); Yujian ZHANG, Cupertino, CA (US); Sergey SOSNIN, Cupertino, CA (US)

(21) Appl. No.: 17/442,506

(22) PCT Filed: Jun. 5, 2020
(86) PCT No.: PCT/US2020/036391

§ 371 Date: Sep. 23, 2021

Related U.S. Application Data
(60) Provisional application No. 62/858,140, filed on Jun. 6, 2019.

(51) Int. Cl. H04W 74/08; H04W 74/00; H04W 72/04; H04W 72/14; H04W 72/12; H04L 1/18; H04L 5/00; H04L 1/00

(52) U.S. Cl. CPC H04W 74/0841; H04W 74/002; H04W 74/0866; H04W 72/044; H04L 1/0061; H04W 72/1263; H04L 1/1812; H04L 5/0053; H04W 72/14

(57) ABSTRACT

Systems, devices, and techniques for random access in a wireless communication network are described. A described technique performed by a user equipment (UE) includes transmitting a first message of a two-step random access procedure to a node of a wireless communication network; receiving, in response to the first message, a downlink control information (DCI) message via a physical downlink control channel (PDCCH) and a second message of the two-step random access procedure via a physical downlink shared channel (PDSCH) in accordance with the DCI message; determining, by the UE, a physical uplink control channel (PUCCH) resource based on the second message; and transmitting, by the UE, hybrid automatic repeat request-acknowledgement (HARQ-ACK) feedback for the second message on the determined PUCCH resource.

### CROSS-REFERENCE TO RELATED APPLICATION

This disclosure claims the benefit of the priority of U.S. Provisional Patent Application No. 62/858,140, entitled “TWO STEP RANDOM ACCESS CHANNEL (RACH) PROCEDURE MsgB RESPONSES” and filed on Jun. 6, 2019. The above-identified application is incorporated herein by reference in its entirety.

### TECHNICAL FIELD

This disclosure relates generally to wireless communication systems.

### BACKGROUND

Base stations, such as a node of radio access network (RAN), can wirelessly communicate with wireless devices such as user equipment (UE). A downlink (DL) transmission refers to a communication from the base station to the wireless device. An uplink (UL) transmission refers to a communication from the wireless device to another device such as the base station. Base stations can transmit control signaling in order to control wireless devices that operate within their network.

### SUMMARY

Systems, devices, and techniques for random access in a wireless communication network are described. Wireless communication networks can provide one or more random access procedures such as two-step and four-step procedures to enable among other things a UE to initiate communications with a base station. A described technique performed by a UE includes transmitting a first message (e.g., MsgA) of a two-step random access procedure to a node of a wireless communication network; receiving, in response to the first message, a downlink control information (DCI) message via a physical downlink control channel (PDCCH) and a second message (e.g., MsgB) of the two-step random access procedure via a physical downlink shared channel (PDSCH) in accordance with the DCI message; determining, by the UE, a physical uplink control channel (PUCCH) resource based on the second message; and transmitting, by the UE, hybrid automatic repeat request-acknowledgement (HARQ-ACK) feedback for the second message on the determined PUCCH resource. Other implementations include corresponding systems, apparatus, communication processor(s), and computer programs to perform the actions of methods defined by instructions encoded on computer readable storage.

These and other implementations can include one or more of the following features. In some implementations, the second message includes an uplink grant field that indicates one or more resources. In some implementations, the determined PUCCH resource is based on the uplink grant field. In some implementations, a cyclic redundancy check (CRC) associated with the DCI message is scrambled by a radio network temporary identity (RNTI) such as a cell RNTI (C-RNTI). In some implementations, a CRC associated with the DCI message is scrambled by a RNTI that is associated with the second message (e.g., MsgB-RNTI). Implementations can include receiving information that provides a configuration of a PUCCH resource set. The second message can include a PUCCH resource indicator field that identifies a resource within the PUCCH resource set, and the determined PUCCH resource is based on the PUCCH resource indicator field.

In some implementations, the second message includes a HARQ feedback timing indicator. In some implementations, the second message includes a random access response (RAR) message, the RAR message includes a PDSCH-to-HARQ feedback timing indicator field, and transmitting the HARQ-ACK feedback can include using a slot that is based on the PDSCH-to-HARQ feedback timing indicator field. In some implementations, transmitting the HARQ-ACK feedback includes using a spatial domain transmission filter that was used in a last physical uplink shared channel (PUSCH) transmission from the UE. In some implementations, the UE is configured to use the same demodulation reference signal (DM-RS) antenna port quasi co-location properties as for a synchronization signal (SS) physical broadcast channel (PBCH) block the UE used for a physical random access channel (PRACH) association.

A UE can include one or more processors, a transceiver, and a memory storing instructions that, when executed by the one or more processors, cause the one or more processors to perform operations described herein. In some implementations, one or more communication processors in a UE can include circuitry, such as a transceiver or an interface to a transceiver, configured to communicate with one or more base stations; and one or more processors coupled with the circuitry. The one or more processors can be configured to perform a random access procedure and provide HARQ feedback.

A base station can include a transceiver; and one or more processors coupled with the transceiver. The one or more processors can be configured to perform a random access procedure such as a 2-step or 4-step random access procedure. The one or more processors can be configured to receive HARQ feedback from a UE.

The details of one or more implementations are set forth in the accompanying drawings and the description below. Other features and advantages will be apparent from the description and drawings, and from the claims.

### BRIEF DESCRIPTION OF DRAWINGS

FIG. 1 illustrates an example of a wireless communication system.

FIG. 2 illustrates an example of a four-step procedure used for an initial contention based random access procedure.

FIG. 3 illustrates an example of a two-step random access procedure.

FIG. 4 illustrates an example of infrastructure equipment.

FIG. 5 illustrates an example of a platform or device.

FIG. 6 illustrates example components of baseband circuitry and radio front end circuitry.

FIG. 7 illustrates example components of cellular communication circuitry.

FIGS. 8A-8F illustrates various protocol functions including medium access control functions that may be implemented in a wireless communication device.

FIG. 9 illustrates an example of a two-step random access procedure that additionally includes a feedback transmission.

FIG. 10 illustrates an example of a procedure to determine PUCCH resource for HARQ-ACK feedback of a corresponding MsgB transmission.

Like reference symbols in the various drawings indicate like elements.

### DETAILED DESCRIPTION

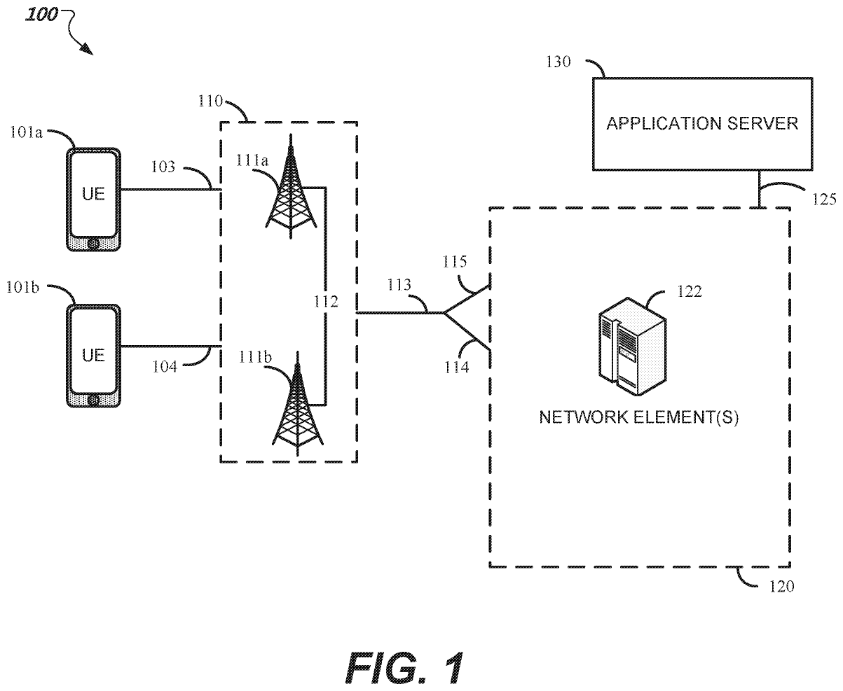

FIG. 1 illustrates an example of a wireless communication system 100. For purposes of convenience and without limitation, the example system 100 is described in the context of the LTE and 5G NR communication standards as defined by the Third Generation Partnership Project (3GPP) technical specifications. However, other types of communication standards are possible.

The system 100 includes UE 101a and UE 101b (collectively referred to as the “UEs 101”). In this example, the UEs 101 are illustrated as smartphones (e.g., handheld touchscreen mobile computing devices connectable to one or more cellular networks). In other examples, any of the UEs 101 may include other mobile or non-mobile computing devices, such as consumer electronics devices, cellular phones, smartphones, feature phones, tablet computers, wearable computer devices, personal digital assistants (PDAs), pagers, wireless handsets, desktop computers, laptop computers, in-vehicle infotainment (IVI), in-car entertainment (ICE) devices, an Instrument Cluster (IC), head-up display (HUD) devices, onboard diagnostic (OBD) devices, dashtop mobile equipment (DME), mobile data terminals (MDTs), Electronic Engine Management System (EEMS), electronic/engine control units (ECUs), electronic/engine control modules (ECMs), embedded systems, microcontrollers, control modules, engine management systems (EMS), networked or “smart” appliances, machine-type communications (MTC) devices, machine-to-machine (M2M) devices, Internet of Things (IoT) devices, or combinations of them, among others.

In some implementations, any of the UEs 101 may be IoT UEs, which can include a network access layer designed for low-power IoT applications utilizing short-lived UE connections. An IoT UE can utilize technologies such as M2M or MTC for exchanging data with an MTC server or device using, for example, a public land mobile network (PLMN), proximity services (ProSe), device-to-device (D2D) communication, sensor networks, IoT networks, or combinations of them, among others. The M2M or MTC exchange of data may be a machine-initiated exchange of data. An IoT network describes interconnecting IoT UEs, which may include uniquely identifiable embedded computing devices (within the Internet infrastructure), with short-lived connections. The IoT UEs may execute background applications (e.g., keep-alive messages or status updates) to facilitate the connections of the IoT network.

The UEs 101 can be configured to connect (e.g., communicatively couple) with RAN 110. The RAN 110 can include one or more RAN nodes 111a and 111b (collectively referred to as “RAN nodes 111” or “RAN node 111”). In some implementations, the RAN 110 may be a next generation RAN (NG RAN), an evolved UMTS terrestrial radio access network (E-UTRAN), or a legacy RAN, such as a UMTS terrestrial radio access network (UTRAN) or a GSM EDGE radio access network (GERAN). As used herein, the term “NG RAN” may refer to a RAN 110 that operates in a 5G NR system 100, and the term “E-UTRAN” may refer to a RAN 110 that operates in an LTE or 4G system 100.

To connect to the RAN 110, the UEs 101 utilize connections (or channels) 103 and 104, respectively, each of which may include a physical communications interface or layer, as described below. In this example, the connections 103 and 104 are illustrated as an air interface to enable communicative coupling, and can be consistent with cellular communications protocols, such as a global system for mobile communications (GSM) protocol, a code-division multiple access (CDMA) network protocol, a push-to-talk (PTT) protocol, a PTT over cellular (POC) protocol, a universal mobile telecommunications system (UMTS) protocol, a 3GPP LTE protocol, a 5G NR protocol, or combinations of them, among other communication protocols.

The RAN 110 can include one or more RAN nodes 111a and 111b (collectively referred to as “RAN nodes 111” or “RAN node 111”) that enable the connections 103 and 104. As used herein, the terms “access node,” “access point,” or the like may describe equipment that provides the radio baseband functions for data or voice connectivity, or both, between a network and one or more users. These nodes 111 can be referred to as base stations (BS), gNodeBs, gNBs, eNodeBs, eNBs, NodeBs, RAN nodes, road side units (RSUs), and the like, and can include ground stations (e.g., terrestrial access points) or satellite stations providing coverage within a geographic area (e.g., a cell), among others. As used herein, the term “NG RAN node” may refer to a RAN node 111 that operates in a 5G NR system 100 (for example, a gNB), and the term “E-UTRAN node” may refer to a RAN node 111 that operates in an LTE or 4G system 100 (e.g., an eNB). In some implementations, the RAN nodes 111 may be implemented as one or more of a dedicated physical device such as a macrocell base station, or a low power (LP) base station for providing femtocells, picocells or other like cells having smaller coverage areas, smaller user capacity, or higher bandwidth compared to macrocells.

The RAN nodes 111 and the UEs 101 can be configured for multiple-input and multiple-output (MIMO) communications, including single or multi-beam communications. For example, a UE 101 can receive transmissions from one RAN node 111 at a time or from multiple RAN nodes 111 at the same time. The RAN nodes 111 and the UEs 101 can use beamforming for the UL, DL, or both. For example, one or more RAN nodes 111 can transmit (Tx) a beam towards a UE 101, and the UE 101 can receive data via one or more receive (Rx) beams at the same time. In some implementations, each of the RAN nodes 111 can be configured as a transmission and reception point (TRP). The RAN 110 can provide signaling for configuring beamforming such as by providing transmission configuration indicator (TCI) state configuration information.

Any of the RAN nodes 111 can terminate the air interface protocol and can be the first point of contact for the UEs 101. In some implementations, any of the RAN nodes 111 can fulfill various logical functions for the RAN 110 including, but not limited to, radio network controller (RNC) functions such as radio bearer management, uplink and downlink dynamic radio resource management and data packet scheduling, and mobility management.

In some implementations, the UEs 101 can be configured to communicate using orthogonal frequency division multiplexing (OFDM) communication signals with each other or with any of the RAN nodes 111 over a multicarrier communication channel in accordance with various communication techniques, such as, but not limited to, OFDMA communication techniques (e.g., for downlink communications) or SC-FDMA communication techniques (e.g., for uplink communications), although the scope of the techniques described here not limited in this respect. The OFDM signals can comprise a plurality of orthogonal subcarriers.

In some implementations, a downlink resource grid can be used for downlink transmissions from any of the RAN nodes 111 to the UEs 101, while uplink transmissions can utilize similar techniques. The grid can be a frequency grid or a time-frequency grid, which is the physical resource in the downlink in each slot. Such a time-frequency plane representation is a common practice for OFDM systems, which makes it intuitive for radio resource allocation. Each column and each row of the resource grid corresponds to one OFDM symbol and one OFDM subcarrier, respectively. The duration of the resource grid in the time domain corresponds to one slot in a radio frame. The smallest time-frequency unit in a resource grid can be denoted as a resource element (RE). Each resource grid can include a number of resource blocks, which describe the mapping of certain physical channels to resource elements. A resource block (RB) can include a collection of resource elements; in the frequency domain, this may represent the smallest quantity of resources that currently can be allocated. Physical downlink and uplink channels can be conveyed using such resource blocks. In some cases, a RB can be referred to as a physical resource block (PRB).

In some implementations, each RE is uniquely identified by the index pair (k,l) in a slot where k=0, . . . , N_{RB}^{DL}N_{sc}^{RB}−1 and l=0, . . . , N_{symb}^{DL}−1 are the indices in the frequency and time domains, respectively. RE (k,l) on antenna port p corresponds to the complex value a_{k,l}^{(p)}. In some implementations, an antenna port can be defined such that the channel over which a symbol on the antenna port is conveyed can be inferred from the channel over which another symbol on the same antenna port is conveyed. There can be one resource grid per antenna port. The set of antenna ports supported can depend on the reference signal configuration in the cell, see, e.g., 3GPP TS 36.211.

The RAN nodes 111 can transmit to the UEs 101 over one or more DL channels. Various examples of DL communication channels include a physical broadcast channel (PBCH), physical downlink control channel (PDCCH), and physical downlink shared channel (PDSCH). The PDSCH can carry user data and higher-layer signaling to the UEs 101. Other types of downlink channels are possible. The UEs 101 can transmit to the RAN nodes 111 over one or more UL channels. Various examples of UL communication channels include physical uplink shared channel (PUSCH), physical uplink control channel (PUCCH), and physical random access channel (PRACH). Other types of uplink channels are possible. Devices such as the RAN nodes 111 and the UEs 101 can transmit reference signals. Examples of reference signals include a synchronization signal block (SSB), sounding reference signal (SRS), channel state information reference signal (CSI-RS), demodulation reference signal (DMRS or DM-RS), and phase tracking reference signal (PTRS). Other types of reference signals are possible.

A channel such as PDCCH can convey scheduling information of different types for one or more downlink and uplink channels. Scheduling information can include downlink resource scheduling, uplink power control instructions, uplink resource grants, and indications for paging or system information. The RAN nodes 111 can transmit one or more downlink control information (DCI) messages on the PDCCH to provide scheduling information, such as allocations of one or more PRBs. In some implementations, a DCI message transports control information such as requests for aperiodic CQI reports, UL power control commands for a channel, and a notification for a group of UEs 101 of a slot format. Downlink scheduling (e.g., assigning control and shared channel resource blocks to the UE 101b within a cell) may be performed at any of the RAN nodes 111 based on channel quality information fed back from any of the UEs 101. The downlink resource assignment information may be sent on the PDCCH used for (e.g., assigned to) each of the UEs 101 or a group of UEs. In some implementations, the PDCCH carries information about the transport format and resource allocations related to the PDSCH channel, among other things. It may also inform the UEs 101 about the transport format, resource allocation, and hybrid automatic repeat request (HARQ) information for providing HARQ feedback on an uplink channel based on a PDSCH reception.

Downlink and uplink transmissions can occur in one or more component carriers (CCs). One or more bandwidth part (BWP) configurations for each component carrier can be configured. In some implementations, a DL BWP includes at least one control resource set (CORESET). In some implementations, a CORESET includes one or more PRBs in a frequency domain, and one or more OFDM symbols in a time domain. In some implementations, channels such as PDCCH can be transmitted via one or more CORESETs, with each CORESET corresponding to a set of time-frequency resources. CORESET information can be provided to a UE 101, and the UE 101 can monitor time-frequency resources associated with one or more CORESETs to receive a PDCCH transmission.

For NR, in some implementations, DL and UL transmissions can be organized into frames with 10 ms durations each of which includes ten 1 ms subframes. The number of consecutive OFDM symbols per subframe can be N_{symb}^{subframe,μ}=N_{symb}^{slot}Nₛₗₒₜ^{subframe,μ}. In some implementations, each frame is divided into two equally-sized half-frames of five subframes each with half-frame 0 comprising subframes 0-4 and half-frame 1 comprising subframes 5-9. There is one set of frames in the UL and one set of frames in the DL on a carrier. Uplink frame number i for transmission from the UE is to start T_{TA}=(N_{TA}+N_{TA,offset})/T_{c} before the start of the corresponding downlink frame at the UE where N_{TA,offset} is given by 3GPP TS 38.213. For subcarrier spacing configuration μ, slots are numbered nₛ^{μ}∈{0, . . . , Nₛₗₒₜ^{subframe,μ}−1} in increasing order within a subframe and n_{s,f}^{μ}∈{0, . . . , Nₛₗₒₜ^{frame,μ}−1} in increasing order within a frame. There are N_{symb}^{slot} consecutive OFDM symbols in a slot where N_{symb}^{slot} depends on the cyclic prefix as given by tables 4.3.2-1 and 4.3.2-2 of 3GPP TS 38.211. The start of slot nₛ^{μ} in a subframe is aligned in time with the start of OFDM symbol nₛ^{μ}N_{symb}^{slot} in the same subframe. OFDM symbols in a slot can be classified as ‘downlink’, ‘flexible’, or ‘uplink’, where downlink transmissions occur in ‘downlink’ or ‘flexible’ symbols and the UEs 101 transmit in ‘uplink’ or ‘flexible’ symbols.

For each numerology and carrier, a resource grid of N_{grid,x}^{size,μ}N_{sc}^{RB} subcarriers and N_{symb}^{subframe,μ} OFDM symbols is defined, starting at a common RB N_{grid}^{start,μ} indicated by higher-layer signaling. There is one set of resource grids per transmission direction (i.e., uplink or downlink) with the subscript x set to DL for downlink and x set to UL for uplink. There is one resource grid for a given antenna port p, subcarrier spacing configuration μ, and transmission direction (i.e., downlink or uplink).

In some implementations, an RB is defined as N_{sc}^{RB}=12 consecutive subcarriers in the frequency domain. Common RBs are numbered from 0 and upwards in the frequency domain for subcarrier spacing configuration μ. In some implementations, the center of subcarrier 0 of common resource block 0 for subcarrier spacing configuration μ coincides with ‘point A’. The relation between the common resource block number n_{CRB}^{μ} in the frequency domain and resource elements (k, l) for subcarrier spacing configuration μ is given by

$${n}_{C R B}^{μ} = ⌊ \frac{k}{{N}_{s c}^{R B}} ⌋$$

where k is defined relative to point A such that k=0 corresponds to the subcarrier centered around point A. Point A serves as a common reference point for resource block grids and is obtained from offsetToPointA for a PCell downlink where offsetToPointA represents the frequency offset between point A and the lowest subcarrier of the lowest resource block, which has the subcarrier spacing provided by the higher-layer parameter subCarrierSpacingCommon and overlaps with the synchronization signal (SS)/PBCH block used by the UE 101 for initial cell selection, expressed in units of resource blocks assuming 15 kHz subcarrier spacing for FR1 and 60 kHz subcarrier spacing for FR2; and absoluteFrequencyPointA for all other cases where absoluteFrequencyPointA represents the frequency-location of point A expressed as in ARFCN.

In some implementations, a PRB for subcarrier configuration μ can be defined within a BWP and numbered from 0 to N_{BWP,i}^{size,μ}−1 where i is the number of the BWP. The relation between the physical resource block n_{PRB}^{μ} in BWPi and the common RB n_{CRB}^{μ} is given by n_{CRB}^{μ}=n_{PRB}^{μ}+N_{BWP,i}^{start,μ} where N_{BWP,i}^{start, μ} is the common RB where BWP starts relative to common RB 0. VRBs can be defined within a BWP and numbered from 0 to N_{BWP,i}^{size}−1 where i is the number of the BWP.

Further, in NR based systems, each element in the resource grid for antenna port p and subcarrier spacing configuration μ can be called a RE and can be uniquely identified by (k,l)_{p,μ} where k is the index in the frequency domain and l refers to the symbol position in the time domain relative to some reference point. Resource element (k, l)_{p,μ} corresponds to a physical resource and the complex value a_{k,l}^{(p, μ)}. In some implementations, an antenna port is defined such that the channel over which a symbol on the antenna port is conveyed can be inferred from the channel over which another symbol on the same antenna port is conveyed. In some implementations, two antenna ports are said to be quasi co-located if the large-scale properties of the channel over which a symbol on one antenna port is conveyed can be inferred from the channel over which a symbol on the other antenna port is conveyed. The large-scale properties can include one or more of delay spread, Doppler spread, Doppler shift, average gain, average delay, and spatial Rx parameters.

In some implementations, a BWP is a subset of contiguous common resource blocks defined in clause 4.4.4.3 of 3GPP TS 38.211 for a given numerology μᵢ in BWP i on a given carrier. The starting position N_{BWP}^{start,μ} and the number of resource blocks N_{BWP,i}^{size,μ} in a BWP is to fulfil N_{grid,x}^{start,μ}≤N_{BWP,i}^{start,μ}<N_{grid,x}^{start,μ}+N_{grid,x}^{size,μ} and N_{grid,x}^{start,μ}<N_{BWP,i}^{start,μ}+N_{BWP,i}^{size,μ}≤N_{grid,x}^{start,μ}+N_{grid,x}^{size,μ}, respectively. Configuration of a BWP is described in clause 12 of 3GPP TS 38.213. In some implementations, the UEs 101 can be configured with up to four BWPs in the DL with a single DL BWP being active at a given time. The UEs 101 are not expected to receive PDSCH, PDCCH, or CSI-RS (except for RRM) outside an active BWP. In some implementations, the UEs 101 can be configured with up to four BWPs in the UL with a single UL BWP being active at a given time. If a UE 101 is configured with a supplementary UL, the UE 101 can be configured with up to four additional BWPs in the supplementary UL with a single supplementary UL BWP being active at a given time. The UEs 101 do not transmit PUSCH or PUCCH outside an active BWP, and for an active cell, the UEs do not transmit SRS outside an active BWP.

In some implementations, the PDSCH carries user data and higher-layer signaling to the UEs 101. Typically, DL scheduling (assigning control and shared channel resource blocks to the UE 101 within a cell) may be performed at any of the RAN nodes 111 based on channel quality information fed back from any of the UEs 101. The downlink resource assignment information may be sent on the PDCCH used for (e.g., assigned to) each of the UEs 101. The PDCCH can use control channel elements (CCEs) to convey control information (e.g., DCI), and a set of CCEs may be referred to a “control region.” Control channels are formed by aggregation of one or more CCEs, where different code rates for the control channels are realized by aggregating different numbers of CCEs. The CCEs are numbered from 0 to N_{CCE,k}−1, where N_{CCE,k}−1 is the number of CCEs in the control region of subframe k. Before being mapped to REs, the PDCCH complex-valued symbols may first be organized into quadruplets, which may then be permuted using a sub-block interleaver for rate matching. Each PDCCH may be transmitted using one or more of these CCEs, where each CCE may correspond to nine sets of four physical REs known as resource element groups (REGs). The PDCCH can be transmitted using one or more CCEs, depending on the size of the DCI and the channel condition. There can be four or more different PDCCH formats defined with different numbers of CCEs (e.g., aggregation level, L=1, 2, 4, or 8 in LTE and L=1, 2, 4, 8, or 16 in NR). The UE 101 monitors a set of PDCCH candidates on one or more activated serving cells as configured by higher layer signaling for control information (e.g., DCI), where monitoring implies attempting to decode each of the PDCCHs (or PDCCH candidates) in the set according to all the monitored DCI formats. The UEs 101 monitor (or attempt to decode) respective sets of PDCCH candidates in one or more configured monitoring occasions according to the corresponding search space configurations.

In some NR implementations, the UEs 101 monitor (or attempt to decode) respective sets of PDCCH candidates in one or more configured monitoring occasions in one or more configured CORESETs according to the corresponding search space configurations. A CORESET may include a set of PRBs with a time duration of 1 to 3 OFDM symbols. A CORESET may additionally or alternatively include N_{RB}^{CORESET} RBs in the frequency domain and N_{symb}^{CORESET}∈{1,2,3} symbols in the time domain. A CORESET can include six REGs numbered in increasing order in a time-first manner, where a REG equals one RB during one OFDM symbol. The UEs 101 can be configured with multiple CORESETS where each CORESET is associated with a CCE-to-REG mapping. Interleaved and non-interleaved CCE-to-REG mapping are supported in a CORESET. Each REG carrying a PDCCH carries its own DMRS.

The UE 101 can perform a 4-step or 2-step random access procedure to initiate a data transfer. A 4-step or 2-step random access procedure can be triggered upon request of a PRACH transmission by higher layers or by a PDCCH order. In some implementations, a 4-step random access procedure can include the transmission of a random access preamble (Msg1) in a PRACH, random access response (RAR) message with a PDCCH/PDSCH (Msg2), and when applicable, a PUSCH transmission carrying Msg3 scheduled by a RAR UL grant, and a PDSCH transmission carrying Msg4 for contention resolution.

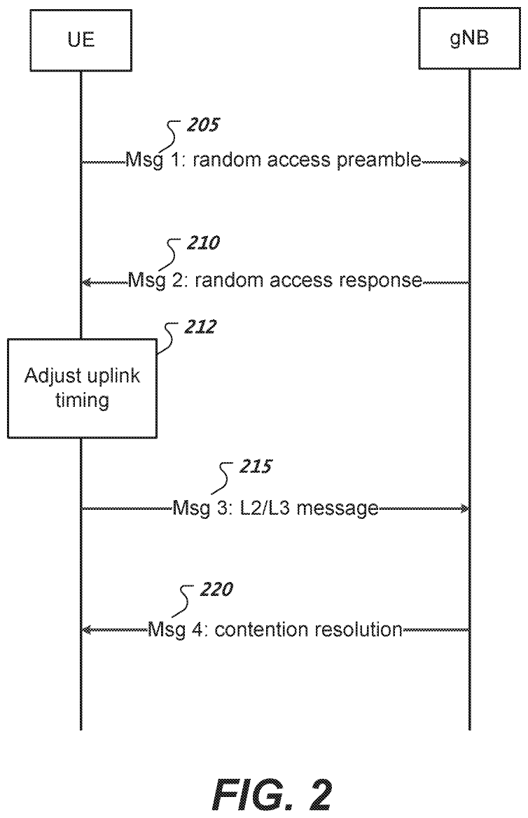

FIG. 2 illustrates an example of a four-step procedure used in NR for initial contention based random access procedure. The procedure can also be referred to as a “RACH procedure.” At 205, the UE transmits a PRACH in the uplink which includes a randomly selected preamble signature (e.g., Msg1: random access preamble) to a gNB. Transmitting PRACH can enable the gNB to estimate the delay between the gNB and the UE for subsequent UL timing adjustment. In some implementations, the random access preamble can be selected in accordance with 3GPP TS 38.213, clause 8.1. At 210, the gNB transmits a RAR message (e.g., Msg2 in FIG. 2) in response to Msg1. The RAR message can include timing advanced (TA) command information and an uplink grant for the uplink transmission. In some implementations, the UE expects to receive the RAR within a time window, of which the start and end are configured by the gNB via SIB. In some implementations, aspects of a random access procedure are based on section 8 of 3GPP TS 38.213.

At 212, the UE adjusts its uplink timing based on the TA command information. At 215, the UE transmits an L2/L3 message (e.g., Msg3 in FIG. 2). Msg3 can include a contention resolution identifier. The Msg3 is a message transmitted on the UL-SCH containing a C-RNTI MAC Control Element (MAC CE) or Common Control Channel (CCCH) Service Data Unit (SDU), submitted from upper layer and associated with the UE contention resolution identity, as part of the random access procedure. At 220, the UE receives a contention resolution message, also known as Msg4, from the gNB. If the UE locates its contention-resolution identifier, the UE can send an acknowledgement on a PUCCH to complete the 4-step random access procedure.

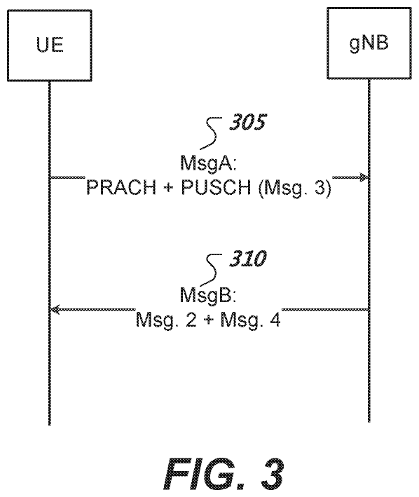

FIG. 3 illustrates an example of a two-step random access procedure. This can also be referred to as a 2-step RACH procedure which can include a first message called MsgA and a second message called MsgB. At 305, the UE transmits MsgA to the gNB (e.g., RAN node 111 of FIG. 1). The MsgA includes a PRACH preamble and a PUSCH carrying payload, which are multiplexed in a time division multiplexing (TDM) manner. The PUSCH carrying payload may include the contents of Msg3 of the 4-step RACH procedure illustrated in FIG. 2. At 310, the gNB transmits a MsgB to the UE. The MsgB includes the contents of Msg2 and Msg4 of the 4-step RACH procedure. For the 2-step RACH procedure, MsgA is a signal for the gNB to detect the UE and its associated payload while the MsgB is for contention resolution for contention-based random access (CBRA) with a possible payload. MsgA can include the equivalent information which is transmitted in Msg3 for the 4-step RACH procedure. The contention resolution in the 2-step RACH procedure is performed by including a UE identifier in the first message (e.g., MsgA), which is echoed in the second message (e.g., MsgB).

In some implementations, prior to initiation (or triggering) of the PRACH procedure, L1 receives from higher layers a set of SS/PBCH block indexes and provides to higher layers a corresponding set of RSRP measurements. The information received by the L1 from the higher layers includes: a configuration of PRACH transmission parameters (e.g., PRACH preamble format, time resources, and frequency resources for PRACH transmission); and parameters for determining the root sequences and their cyclic shifts in the PRACH preamble sequence set (e.g., index to logical root sequence table, cyclic shift (N_{CS}), and set type (unrestricted, restricted set A, or restricted set B)). The PRACH is transmitted using the selected PRACH format with transmission power P_{PRACH,b,f,c}(i), as described in clause 7.4 of 3GPP TS 38.213, on the indicated PRACH resource (see e.g., Step 205 (Msg1) of FIG. 2 and/or Step 305 (MsgA) of FIG. 3).

In response to a PRACH transmission (see, e.g., Step 210 (Msg2) of FIG. 2 and/or Step 305 (MsgA) of FIG. 3), the UE 101 attempts to detect a DCI format 1_0 with CRC scrambled by a corresponding random access-RNTI (RA-RNTI) during a window controlled by higher layers (see e.g., 3GPP TS 38.321). The window starts at the first symbol of the earliest CORESET the UE 101 is configured to receive PDCCH for Type1-PDCCH CSS set, as defined in clause 10.1 of 3GPP TS 38.213, that is at least one symbol, after the last symbol of the PRACH occasion corresponding to the PRACH transmission, where the symbol duration corresponds to the SCS for Type1-PDCCH CSS set as defined in clause 10.1 of 3GPP TS 38.213. The length of the window in number of slots, based on the SCS for Type1-PDCCH CSS set, is provided by ra-ResponseWindow.

If the UE 101 detects the DCI format 1_0 with CRC scrambled by the corresponding RA-RNTI and a transport block in a corresponding PDSCH within the window, the UE 101 passes the transport block to higher layers. The higher layers parse the transport block for a random access preamble identity (RAPID) associated with the PRACH transmission. If the higher layers identify the RAPID in RAR message(s) of the transport block, the higher layers indicate an uplink grant to the physical layer. This is referred to as random access response (RAR) UL grant in the physical layer.

A RAR UL grant can schedule a PUSCH transmission from the UE 101 (see, e.g., Step 215 (Msg3) of FIG. 2 and/or Step 310 (MsgB) of FIG. 3). In some implementations, the contents of the RAR UL grant are provided by Table 1. If the value of the frequency hopping flag is 0, the UE 101 transmits the PUSCH without frequency hopping; otherwise, the UE 101 transmits the PUSCH with frequency hopping. The UE 101 determines the modulation and coding scheme (MCS) for the PUSCH transmission from the sixteen indexes of the applicable MCS index table for PUSCH as described in 3GPP TS 38.214. The TPC command value δ_{msg2,b,f,c} is used for setting the power of the PUSCH transmission, as described in clause 7.1.1 of 3GPP TS 38.213, and is interpreted according to Table 2. The CSI request field is reserved.

TABLE 1
Random Access Response Grant Content field size

| RAR grant field | Number of bits |
|---|---|
| Frequency hopping flag | 1 |
| PUSCH frequency resource allocation | 14 |
| PUSCH time resource allocation | 4 |
| MCS | 4 |
| TPC command for PUSCH | 3 |
| CSI request | 1 |

TABLE 2
TPC Command for PUSCH

| TPC Command | Value (in dB) |
|---|---|
| 0 | −6 |
| 1 | −4 |
| 2 | −2 |
| 3 | 0 |
| 4 | 2 |
| 5 | 4 |
| 6 | 6 |
| 7 | 8 |

In some implementations, if the UE 101 does not detect the DCI format 1_0 with CRC scrambled by the corresponding RA-RNTI within the window, or if the UE 101 does not correctly receive the transport block in the corresponding PDSCH within the window, or if the higher layers do not identify the RAPID associated with the PRACH transmission from the UE, the higher layers can indicate to the physical layer to transmit a PRACH. If requested by higher layers, the UE 101 is expected to transmit a PRACH no later than N_{T,1}+0.75 msec after the last symbol of the window, or the last symbol of the PDSCH reception, where N_{T,1} is a time duration of N₁ symbols corresponding to a PDSCH reception time for UE 101 processing capability 1 when additional PDSCH DM-RS is configured.

If the UE 101 detects a DCI format 1_0 with CRC scrambled by the corresponding RA-RNTI and receives a transport block in a corresponding PDSCH, the UE 101 may assume same DM-RS antenna port quasi co-location properties, as described in 3GPP TS 38.214, as for a SS/PBCH block or a CSI-RS resource the UE 101 used for PRACH association, as described in clause 8.1 of 3GPP TS 38.213, regardless of whether or not the UE 101 is provided TCI-State for the CORESET where the UE 101 receives the PDCCH with the DCI format 1_0. If the UE 101 attempts to detect the DCI format 1_0 with CRC scrambled by the corresponding RA-RNTI in response to a PRACH transmission initiated by a PDCCH order that triggers a non-contention based random access procedure for the SpCell (see, e.g., 3GPP TS 38.321), the UE 101 may assume that the PDCCH that includes the DCI format 1_0 and the PDCCH order have same DM-RS antenna port quasi co-location properties. If the UE 101 attempts to detect the DCI format 1_0 with CRC scrambled by the corresponding RA-RNTI in response to a PRACH transmission initiated by a PDCCH order that triggers a non-contention based random access procedure for a secondary cell, the UE 101 may assume the DM-RS antenna port quasi co-location properties of the CORESET associated with the Type1-PDCCH CSS set for receiving the PDCCH that includes the DCI format 10.

In some implementations, unless the UE 101 is configured with a Subcarrier Spacing (SCS), the UE 101 receives subsequent PDSCH using same SCS as for the PDSCH reception providing the RAR message. If the UE 101 does not detect the DCI format with CRC scrambled by the corresponding RA-RNTI or the UE 101 does not correctly receive a corresponding transport block within the window, the UE 101 procedure can be as described in 3GPP TS 38.321.

The UE 101 transmits a Msg3 or MsgB in response to the RAR (see, e.g., Step 215 (Msg3) of FIG. 2 and/or Step 310 (MsgB) of FIG. 3). An active UL BWP, as described in clause 12 of 3GPP TS 38.211, for a PUSCH transmission scheduled by a RAR UL grant can be indicated by higher layers. For determining the frequency domain resource allocation for the PUSCH transmission within the active UL BWP, if the active UL BWP and the initial UL BWP have the same SCS and the same CP length and the active UL BWP includes all RBs of the initial UL BWP, or the active UL BWP is the initial UL BWP, the initial UL BWP is used; else, the RB numbering starts from the first RB of the active UL BWP and the maximum number of RBs for frequency domain resource allocation equals the number of RBs in the initial UL BWP.

The frequency domain resource allocation is by uplink resource allocation type 1 (see, e.g., 3GPP TS 38.214). For an initial UL BWP size of N_{BWP}^{size} RBs, a UE 101 processes the frequency domain resource assignment field as follows: if N_{BWP}^{size}≤180, truncate the frequency domain resource assignment field to its ┌log₂(N_{BWP}^{size}·(N_{BWP}^{size}+1)/2)┐ least significant bits and interpret the truncated frequency resource assignment field as for the frequency resource assignment field in DCI format 0_0 as described in 3GPP TS 38.212; else, insert ┌log₂(N_{BWP}^{size}·(N_{BWP}^{size}+1)/2)┐−14 most significant bits with value set to ‘0’ after the N_{IL,hop} bits to the frequency domain resource assignment field, where N_{UL,hop}=0 if the frequency hopping flag is set to ‘0’ and N_{UL,hop} is provided in Table 3 if the hopping flag bit is set to ‘1’, and interpret the expanded frequency resource assignment field as for the frequency resource assignment field in DCI format 0_0 as described in 3GPP TS 38.212; end if, the UE 101 is indicated by msg3-transformPrecoder whether or not the UE 101 shall apply transform precoding, as described in 3GPP TS 38.211, for a PUSCH transmission scheduled by a RAR UL grant. For PUSCH transmission with frequency hopping scheduled by RAR UL grant, the frequency offset for the second hop (see, e.g., 3GPP TS 38.214) is given in Table 3.

TABLE 3
Frequency offset for second hop of PUSCH transmission
with frequency hopping scheduled by RAR UL grant

| Number of PRBs in | Value of N_{UL, hop} | Frequency offset |
|---|---|---|
| initial UL BWP | Hopping Bits | for 2^{nd} hop |
| N_{BWP}^{size} < 50 | 0 | └N _{BWP}^{size}/2┘ |
| | 1 | └N _{BWP}^{size}/4┘ |
| N_{BWP}^{size} ≥ 50 | 00 | └N _{BWP}^{size}/2┘ |
| | 01 | └N _{BWP}^{size}/4┘ |
| | 10 | −└N _{BWP}^{size}/4┘ |
| | 11 | Reserved |

A SCS for the PUSCH transmission can be provided by SubcarrierSpacing in BWP-UplinkCommon. The UE 101 transmits PRACH and the PUSCH on a same uplink carrier of a same serving cell. The UE 101 transmits a transport block in a PUSCH scheduled by a RAR UL grant in a corresponding RAR message using redundancy version number 0. For Msg3 PUSCH retransmissions, if any, of the transport block are scheduled by a DCI format 0_0 with CRC scrambled by a TC-RNTI provided in the corresponding RAR message (see, e.g., 3GPP TS 38.321). The UE 101 transmits the PUSCH scheduled by a RAR UL grant without repetitions.

With reference to slots for a PUSCH transmission scheduled by a RAR UL grant, if the UE 101 receives a PDSCH with a RAR message ending in slot n for a corresponding PRACH transmission from the UE, the UE 101 transmits the PUSCH in slot n+k₂+Δ, where k₂ and Δ are provided in 3GPP TS 38.214.

The UE 101 may assume a minimum time between the last symbol of a PDSCH reception conveying a RAR message with a RAR UL grant and the initial symbol of a corresponding PUSCH transmission scheduled by the RAR UL grant is equal to N_{T,1}+N_{T,2}+0.5 msec, where N_{T,1} is a time duration of N₁ symbols corresponding to a PDSCH reception time for UE 101 processing capability 1 when additional PDSCH DM-RS is configured, N_{T,2} is a time duration of N₂ symbols corresponding to a PUSCH preparation time for UE 101 processing capability 1 (see, e.g., 3GPP TS 38.214) and, for determining the minimum time, the UE 101 considers that N₁ and N₂ correspond to the smaller of the SCS configurations for the PDSCH and the PUSCH.

After transmission of Msg3, the UE 101 receives a PDSCH with a UE contention resolution identity (see, e.g., Step 220 (Msg4) of FIG. 2 and/or Step 310 (MsgB) of FIG. 3). In response to a PUSCH transmission scheduled by a RAR UL grant when the UE 101 has not been provided a C-RNTI, the UE 101 attempts to detect a DCI format 1_0 with CRC scrambled by a corresponding TC-RNTI scheduling a PDSCH that includes a UE contention resolution identity (see, e.g., 3GPP TS 38.321). In response to the PDSCH reception with the UE contention resolution identity, the UE 101 transmits HARQ-ACK information in a PUCCH. The PUCCH transmission is within a same active UL BWP as the PUSCH transmission. A minimum time between the last symbol of the PDSCH reception and the first symbol of the corresponding PUCCH transmission with the HARQ-ACK information is equal to N_{T,1}+0.5 msec. N_{T,1} is a time duration of N₁ symbols corresponding to a PDSCH reception time for UE processing capability 1 when additional PDSCH DM-RS is configured.

When detecting a DCI format in response to a PUSCH transmission scheduled by a RAR UL grant (see, e.g., 3GPP TS 38.321), or corresponding PUSCH retransmission scheduled by a DCI format 0_0 with CRC scrambled by a TC-RNTI provided in the corresponding RAR message (see, e.g., 3GPP TS 38.321), the UE 101 may assume the PDCCH carrying the DCI format has the same DM-RS antenna port quasi co-location properties, (see, e.g., 3GPP TS 38.214), as for a SS/PBCH block the UE 101 used for PRACH association (see, e.g., 3GPP TS 38.213, clause 8.1), regardless of whether or not the UE 101 is provided TCI-State for the CORESET where the UE 101 receives the PDCCH with the DCI format.

The UE 101 can report uplink control information (UCI) in the PUCCH. UCI types reported in the PUCCH include HARQ-ACK information, SR, and/or CSI. UCI bits include HARQ-ACK information bits, if any, SR information bits, if any, and CSI bits, if any. In some implementations, the HARQ-ACK information bits correspond to a HARQ-ACK codebook as described in clause 9.1 of 3GPP TS 38.213. The UE 101 may transmit one or two PUCCHs on a serving cell in different symbols within a slot of N_{symb}^{slot} symbols as defined in 3GPP TS 38.211. When the UE 101 transmits two PUCCHs in a slot, at least one of the two PUCCHs uses PUCCH format 0 or PUCCH format 2. For the determination of the number of PRBs in clauses 9.2.3, 9.2.5.1, and 9.2.5.2 of 3GPP TS 38.213, the UE 101 assumes 11 CRC bits if a number of respective UCI bits is larger than or equal to 360; otherwise, the UE 101 determines a number of CRC bits based on the number of respective UCI bits as described in 3GPP TS 38.212. Moreover, a PUCCH transmission with HARQ-ACK information can be subject to the limitations for UE 101 transmissions described in clause 11.1 and clause 11.1.1 of 3GPP TS 38.213.

If the UE 101 is not transmitting PUSCH, and the UE 101 is transmitting UCI, the UE 101 transmits UCI in the PUCCH using: PUCCH format 0 if the transmission is over 1 symbol or 2 symbols, and the number of HARQ-ACK information bits with positive or negative SR (HARQ-ACK/SR bits) is 1 or 2; PUCCH format 1 if the transmission is over 4 or more symbols, and the number of HARQ-ACK/SR bits is 1 or 2; PUCCH format 2 if the transmission is over 1 symbol or 2 symbols, and the number of UCI bits is more than 2; PUCCH format 3 if the transmission is over 4 or more symbols, the number of UCI bits is more than 2, and the PUCCH resource does not include an orthogonal cover code; and/or PUCCH format 4 if the transmission is over 4 or more symbols, the number of UCI bits is more than 2, and the PUCCH resource includes an orthogonal cover code.

A spatial setting for a PUCCH transmission can be provided by PUCCH-SpatialRelationInfo if the UE 101 is configured with a single value for pucch-SpatialRelationInfoId; otherwise, if the UE 101 is provided multiple values for PUCCH-SpatialRelationInfo, the UE 101 determines a spatial setting for the PUCCH transmission as described in 3GPP TS 38.321. The UE 101 applies corresponding actions in 3GPP TS 38.321 and a corresponding setting for a spatial domain filter to transmit PUCCH 3 ms after the slot where the UE 101 transmits HARQ-ACK information with ACK value corresponding to a PDSCH reception providing the PUCCH-SpatialRelationInfo. If PUCCH-SpatialRelationInfo provides ssb-Index, the UE 101 transmits the PUCCH using a same spatial domain filter as for a reception of a SS/PBCH block with index provided by ssb-Index for a same serving cell or, if servingCellId is provided, for a serving cell indicated by servingCellId; else if PUCCH-SpatialRelationInfo provides csi-RS-Index, the UE 101 transmits the PUCCH using a same spatial domain filter as for a reception of a CSI-RS with resource index provided by csi-RS-Index for a same serving cell or, if servingCellId is provided, for a serving cell indicated by servingCellId; else PUCCH-SpatialRelationInfo provides srs, the UE 101 transmits the PUCCH using a same spatial domain filter as for a transmission of a SRS with resource index provided by resource for a same serving cell and/or active UL BWP or, if servingCellId and/or uplinkBWP are provided, for a serving cell indicated by servingCellId and/or for an UL BWP indicated by uplinkBWP.

In some implementations, a number of DM-RS symbols for a PUCCH transmission using PUCCH format 3 or 4 can be provided by additionalDMRS. Use of π/2-PBSK, instead of QPSK, for a PUCCH transmission using PUCCH format 3 or 4 can be indicated by pi2BPSK.

In some implementations, the UE 101 does not expect to transmit more than one PUCCH with HARQ-ACK information in a slot. For DCI format 1_0, the PDSCH-to-HARQ-timing_indicator field values map to {1, 2, 3, 4, 5, 6, 7, 8}. For DCI format 1_1, if present, the PDSCH-to-HARQ-timing-indicator field values map to values for a set of number of slots provided by dl-DataToUL-ACK as defined in Table 4.

For a SPS PDSCH reception ending in slot n, the UE 101 transmits the PUCCH in slot n+k where k is provided by the PDSCH-to-HARQ-timing-indicator field in DCI format 1_0 or, if present, in DCI format 1_1 activating the SPS PDSCH reception.

If the UE 101 detects a DCI format 1_1 that does not include a PDSCH-to-HARQ-timing_indicator field and schedules a PDSCH reception or activates a SPS PDSCH reception ending in slot n, the UE 101 provides corresponding HARQ-ACK information in a PUCCH transmission within slot n+k where k is provided by dl-DataToUL-ACK.

With reference to slots for PUCCH transmissions, if the UE 101 detects a DCI format 1_0 or a DCI format 1_1 scheduling a PDSCH reception ending in slot n or if the UE 101 detects a DCI format 1_0 indicating a SPS PDSCH release through a PDCCH reception ending in slot n, the UE 101 provides corresponding HARQ-ACK information in a PUCCH transmission within slot n+k, where k is a number of slots and is indicated by the PDSCH-to-HARQ_timing-indicator field in the DCI format, if present, or provided by dl-DataToUL-ACK. k=0 corresponds to the last slot of the PUCCH transmission that overlaps with the PDSCH reception or with the PDCCH reception in case of SPS PDSCH release.

TABLE 4
Mapping of PDSCH-to-HARQ_feedback timing
indicator field values to numbers of slots

| PDSCH-to-HARQ_feedback timing indicator | | | |
|---|---|---|---|
| 1 bit | 2 bits | 3 bits | Number of slots k |
| ′0′ | ′00′ | ′000′ | 1^{st} value provided |
| | | | by dl-DataToUL-ACK |
| ′1′ | ′01′ | ′001′ | 2^{nd} value provided |
| | | | by dl-DataToUL-ACK |
| | ′10′ | ′010′ | 3^{rd} value provided |
| | | | by dl-DataToUL-ACK |
| | ′11′ | ′011′ | 4^{th} value provided |
| | | | by dl-DataToUL-ACK |
| | | ′100′ | 5^{th} value provided |
| | | | by dl-DataToUL-ACK |
| | | ′101′ | 6^{th} value provided |
| | | | by dl-DataToUL-ACK |
| | | ′110′ | 7^{th} value provided |
| | | | by dl-DataToUL-ACK |
| | | ′111′ | 8^{th} value provided |
| | | | by dl-DataToUL-ACK |

For a PUCCH transmission with HARQ-ACK information, a UE 101 determines a PUCCH resource after determining a set of PUCCH resources for O_{UCI} HARQ-ACK information bits (see, e.g., 3GPP TS 38.213, clause 9.2.1). The PUCCH resource determination is based on a PUCCH resource indicator field (see, e.g., 3GPP TS 38.212) in a last DCI format 1_0 or DCI format 1_1, among the DCI formats 1_0 or DCI formats 1_1 that have a value of a PDSCH-to-HARQ_feedback timing indicator field indicating a same slot for the PUCCH transmission, that the UE 101 detects and for which the UE 101 transmits corresponding HARQ-ACK information in the PUCCH where, for PUCCH resource determination, detected DCI formats are first indexed in an ascending order across serving cells indexes for a same PDCCH monitoring occasion and are then indexed in an ascending order across PDCCH monitoring occasion indexes.

In some implementations, the PUCCH resource indicator field values map to values of a set of PUCCH resource indexes, as defined in Table 5, provided by ResourceList for PUCCH resources from a set of PUCCH resources provided by PUCCH-ResourceSet with a maximum of eight PUCCH resources.

For the first set of PUCCH resources and when the size R_{PUCCH} of resourceList is larger than eight, when a UE 101 provides HARQ-ACK information in a PUCCH transmission in response to detecting a last DCI format 1_0 or DCI format 1_1 in a PDCCH reception, among DCI formats 1_0 or DCI formats 1_1 with a value of the PDSCH-to-HARQ_feedback timing indicator field indicating a same slot for the PUCCH transmission, the UE 101 determines a PUCCH resource with index r_{PUCCH} 0≤r_{PUCCH}≤R_{PUCCH}−1, as

$${r}_{PUCCH} = \{ \begin{matrix}\begin{matrix}⌊ \frac{{n}_{CCE , p} \cdot ⌈ {R}_{PUCCH} / 8 ⌉}{{N}_{CCE , p}} ⌋ + \\ {Δ}_{PRI} \cdot ⌈ \frac{{R}_{PUCCH}}{8} ⌉\end{matrix} & if {Δ}_{PRI} < {R}_{PUCCH} mod 8 \\ \begin{matrix}⌊ \frac{{n}_{CCE , p} \cdot ⌊ {R}_{PUCCH} / 8 ⌋}{{N}_{CCE , p}} ⌋ + {Δ}_{PRI} \cdot \\ ⌊ \frac{{R}_{PUCCH}}{8} ⌋ + {R}_{PUCCH} mod 8\end{matrix} & if {Δ}_{PRI} \geq {R}_{PUCCH} mod 8\end{matrix} \}$$

where N_{CCE,p} is a number of CCEs in CORESET p of the PDCCH reception for the DCI format 1_0 or DCI format 1_1 as described in clause 10.1, n_{CCE, p} is the index of a first CCE for the PDCCH reception, and Δ_{PRI} is a value of the PUCCH resource indicator field in the DCI format 1_0 or DCI format 1_1.

TABLE 5
Mapping of PUCCH resource indication field
values to a PUCCH resource in a PUCCH resource
set with maximum 8 PUCCH resources

| PUCCH resource indicator | PUCCH resource |
|---|---|
| ′000′ | 1^{st} PUCCH resource provided |
| | by pucch-ResourceId obtained from |
| | the 1^{st} value of resourceList |
| ′001′ | 2^{nd} PUCCH resource provided by |
| | pucch-ResourceId obtained from |
| | the 2^{nd} value of resourceList |
| ′010′ | 3^{rd} PUCCH resource provided |
| | by pucch-ResourceId obtained from |
| | the 3^{rd} value of resourceList |
| ′011′ | 4^{th} PUCCH resource provided |
| | by pucch-ResourceId obtained from |
| | the 4^{th} value of resourceList |
| ′100′ | 5^{th} PUCCH resource provided |
| | by pucch-ResourceId obtained from |
| | the 5^{th} value of resourceList |
| ′101′ | 6^{th} PUCCH resource provided |
| | by pucch-ResourceId obtained from |
| | the 6^{th} value of resourceList |
| ′110′ | 7^{th} PUCCH resource provided |
| | by pucch-ResourceId obtained from |
| | the 7^{th} value of resourceList |
| ′111′ | 8^{th} PUCCH resource provided |
| | by pucch-ResourceId obtained from |
| | the 8^{th} value of resourceList |

If a UE 101 detects a first DCI format 1_0 or DCI format 1_1 indicating a first resource for a PUCCH transmission with corresponding HARQ-ACK information in a slot and also detects at a later time a second DCI format 1_0 or DCI format 1_1 indicating a second resource for a PUCCH transmission with corresponding HARQ-ACK information in the slot, the UE 101 does not expect to multiplex HARQ-ACK information corresponding to the second DCI format in a PUCCH resource in the slot if the PDCCH reception that includes the second DCI format is not earlier than N₃ symbols from a first symbol of the first resource for PUCCH transmission in the slot where, for UE 101 processing capability 1 and SCS configuration μ, N₃=8 for μ=0, N₃=10 for μ=1, N₃=17 for μ=2, N₃=20 for μ=3, and for UE 101 processing capability 2 and SCS configuration μ, N₃=3 for μ=0, N₃=4.5 for μ=1, N₃=9 for μ=2.

In some implementations, if the UE 101 transmits HARQ-ACK information corresponding only to a PDSCH reception without a corresponding PDCCH, a PUCCH resource for corresponding PUCCH transmission with HARQ-ACK information is provided by n1PUCCH-AN. In some implementations, if a UE 101 transmits a PUCCH with HARQ-ACK information using PUCCH format 0, the UE 101 determines values m₀ and m_{CS} for computing a value of cyclic shift α (see, e.g., 3GPP TS 38.211) where m₀ is provided by initialCyclicShift of PUCCH-format0 or, if initialCyclicShift is not provided, by the initial cyclic shift index as described in clause 9.2.1 of 3GPP TS 38.213 and m_{CS} is determined from the value of one HARQ-ACK information bit or from the values of two HARQ-ACK information bits as in Table 6 and Table 7, respectively.

TABLE 6
Mapping of values for one HARQ-ACK information
bit to sequences for PUCCH format 0

| HARQ-ACK Value | 0 | 1 |
|---|---|---|
| Sequence cyclic shift | m_{cs} = 0 | m_{cs} = 6 |

TABLE 7
Mapping of values for two HARQ-ACK information
bits to sequences for PUCCH format 0

| HARQ-ACK Value | {0, 0} | {0, 1} | {1, 1} | {1, 0} |
|---|---|---|---|---|
| Sequence cyclic shift | m_{cs} = 0 | m_{cs} = 3 | m_{cs} = 6 | m_{cs} = 9 |

If the UE 101 transmits a PUCCH with HARQ-ACK information using PUCCH format 1, the UE 101 is provided a value for m₀ by initialCyclicShift of PUCCH-format1. If the UE 101 transmits a PUCCH with O_{ACK} HARQ-ACK information bits and O_{CRC} bits using PUCCH format 2 or PUCCH format 3 in a PUCCH resource that includes M_{RB}^{PUCCH} PRBs, the UE 101 determines a number of PRBs M_{RB}^{PUCCH} for the PUCCH transmission to be the minimum number of PRBs, that is smaller than or equal to a number of PRBs M_{RB}^{PUCCH} provided respectively by nrofPRBs of PUCCH-format2 or nrofPRBs of PUCCH-format3 and start from the first PRB from the number of PRBs, that results to (O_{ACK}+O_{CRC})≤M_{RB,min}^{PUCCH}·N_{sc,ctrl}^{RB}·N_{symb-UCI}^{PUCCH}·Qₘ·r and, if M_{RB}^{PUCCH}>1, (O_{ACK}+O_{CRC})>(M_{RB,min}^{PUCCH}−1)·N_{sc,ctrl}^{RB}·N_{symb-UCI}^{PUCCH}·Qₘ·r, where N_{sc,ctrl}^{RB}, N_{symb-UCI}^{PUCCH}, Qₘ, and r are defined in clause 9.2.5.2 of 3GPP TS 38.213. If (O_{ACK}+O_{CRC})>(M_{RB}^{PUCCH}−1)·N_{sc,ctrl}^{RB}·N_{symb-UCI}^{PUCCH}·Qₘ·r, the UE 101 transmits the PUCCH over M_{RB}^{PUCCH} PRBs.

The RAN nodes 111 are configured to communicate with one another using an interface 112. In examples, such as where the system 100 is an LTE system (e.g., when the core network 120 is an evolved packet core (EPC) network as shown in FIG. 2), the interface 112 may be an X2 interface 112. The X2 interface may be defined between two or more RAN nodes 111 (e.g., two or more eNBs and the like) that connect to the EPC 120, or between two eNBs connecting to EPC 120, or both. In some implementations, the X2 interface may include an X2 user plane interface (X2-U) and an X2 control plane interface (X2-C). The X2-U may provide flow control mechanisms for user data packets transferred over the X2 interface, and may be used to communicate information about the delivery of user data between eNBs. For example, the X2-U may provide specific sequence number information for user data transferred from a master eNB to a secondary eNB; information about successful in sequence delivery of PDCP protocol data units (PDUs) to a UE 101 from a secondary eNB for user data; information of PDCP PDUs that were not delivered to a UE 101; information about a current minimum desired buffer size at the secondary eNB for transmitting to the UE user data, among other information. The X2-C may provide intra-LTE access mobility functionality, including context transfers from source to target eNBs or user plane transport control; load management functionality; inter-cell interference coordination functionality, among other functionality.

In some implementations, such as where the system 100 is a 5G NR system (e.g., when the core network 120 is a 5G core network), the interface 112 may be an Xn interface 112. The Xn interface may be defined between two or more RAN nodes 111 (e.g., two or more gNBs and the like) that connect to the 5G core network 120, between a RAN node 111 (e.g., a gNB) connecting to the 5G core network 120 and an eNB, or between two eNBs connecting to the 5G core network 120, or combinations of them. In some implementations, the Xn interface may include an Xn user plane (Xn-U) interface and an Xn control plane (Xn-C) interface. The Xn-U may provide non-guaranteed delivery of user plane PDUs and support/provide data forwarding and flow control functionality. The Xn-C may provide management and error handling functionality, functionality to manage the Xn-C interface; mobility support for UE 101 in a connected mode (e.g., CM-CONNECTED) including functionality to manage the UE mobility for connected mode between one or more RAN nodes 111, among other functionality. The mobility support may include context transfer from an old (source) serving RAN node 111 to new (target) serving RAN node 111, and control of user plane tunnels between old (source) serving RAN node 111 to new (target) serving RAN node 111. A protocol stack of the Xn-U may include a transport network layer built on Internet Protocol (IP) transport layer, and a GPRS tunneling protocol for user plane (GTP-U) layer on top of a user datagram protocol (UDP) or IP layer(s), or both, to carry user plane PDUs. The Xn-C protocol stack may include an application layer signaling protocol (referred to as Xn Application Protocol (Xn-AP or XnAP)) and a transport network layer that is built on a stream control transmission protocol (SCTP). The SCTP may be on top of an IP layer, and may provide the guaranteed delivery of application layer messages. In the transport IP layer, point-to-point transmission is used to deliver the signaling PDUs. In other implementations, the Xn-U protocol stack or the Xn-C protocol stack, or both, may be same or similar to the user plane and/or control plane protocol stack(s) shown and described herein.

The RAN 110 is shown to be communicatively coupled to a core network 120 (referred to as a “CN 120”). The CN 120 includes one or more network elements 122, which are configured to offer various data and telecommunications services to customers/subscribers (e.g., users of UEs 101) who are connected to the CN 120 using the RAN 110. The components of the CN 120 may be implemented in one physical node or separate physical nodes and may include components to read and execute instructions from a machine-readable or computer-readable medium (e.g., a non-transitory machine-readable storage medium). In some implementations, network functions virtualization (NFV) may be used to virtualize some or all of the network node functions described here using executable instructions stored in one or more computer-readable storage mediums, as described in further detail below. A logical instantiation of the CN 120 may be referred to as a network slice, and a logical instantiation of a portion of the CN 120 may be referred to as a network sub-slice. NFV architectures and infrastructures may be used to virtualize one or more network functions, alternatively performed by proprietary hardware, onto physical resources comprising a combination of industry-standard server hardware, storage hardware, or switches. In other words, NFV systems can be used to execute virtual or reconfigurable implementations of one or more network components or functions, or both.

An application server 130 may be an element offering applications that use IP bearer resources with the core network (e.g., UMTS packet services (PS) domain, LTE PS data services, among others). The application server 130 can also be configured to support one or more communication services (e.g., VoIP sessions, PTT sessions, group communication sessions, social networking services, among others) for the UEs 101 using the CN 120. The application server 130 can use an IP communications interface 125 to communicate with one or more network elements 122.

In some implementations, the CN 120 may be a 5G core network (referred to as “5GC 120” or “5G core network 120”), and the RAN 110 may be connected with the CN 120 using a next generation interface 113. In some implementations, the next generation interface 113 may be split into two parts, an next generation user plane (NG-U) interface 114, which carries traffic data between the RAN nodes 111 and a user plane function (UPF), and the S1 control plane (NG-C) interface 115, which is a signaling interface between the RAN nodes 111 and access and mobility management functions (AMFs).

In some implementations, the CN 120 may be an EPC (referred to as “EPC 120” or the like), and the RAN 110 may be connected with the CN 120 using an S1 interface 113. In some implementations, the S1 interface 113 may be split into two parts, an S1 user plane (S1-U) interface 114, which carries traffic data between the RAN nodes 111 and the serving gateway (S-GW), and the S1-MME interface 115, which is a signaling interface between the RAN nodes 111 and mobility management entities (MMEs).

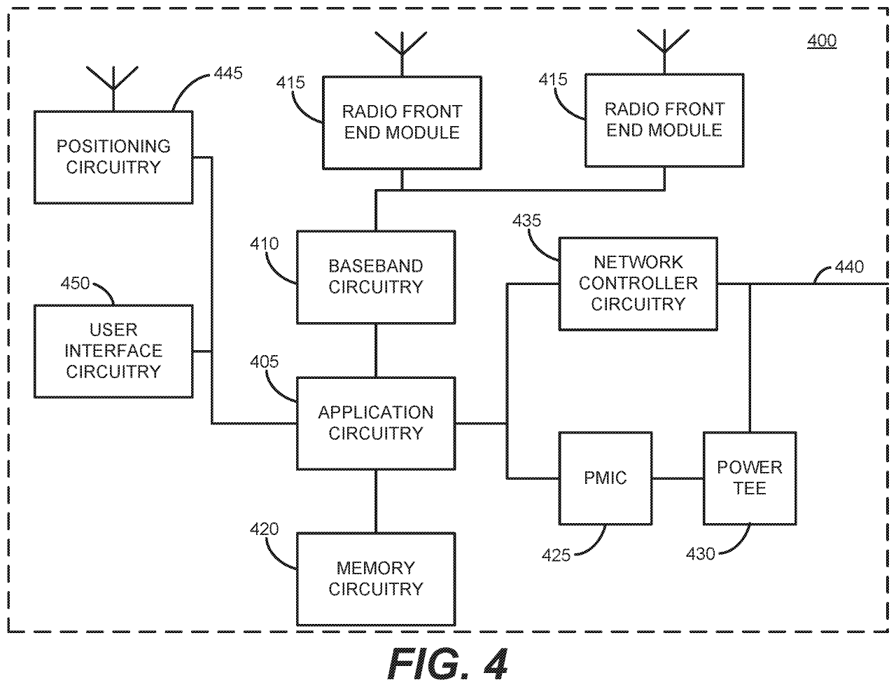

In some implementations, some or all of the RAN nodes 111 may be implemented as one or more software entities running on server computers as part of a virtual network, which may be referred to as a cloud RAN (CRAN) or a virtual baseband unit pool (vBBUP). The CRAN or vBBUP may implement a RAN function split, such as a packet data convergence protocol (PDCP) split in which radio resource control (RRC) and PDCP layers are operated by the CRAN/vBBUP and other layer two (e.g., data link layer) protocol entities are operated by individual RAN nodes 111; a medium access control (MAC)/physical layer (PHY) split in which RRC, PDCP, MAC, and radio link control (RLC) layers are operated by the CRAN/vBBUP and the PHY layer is operated by individual RAN nodes 111; or a “lower PHY” split in which RRC, PDCP, RLC, and MAC layers and upper portions of the PHY layer are operated by the CRAN/vBBUP and lower portions of the PHY layer are operated by individual RAN nodes 111. This virtualized framework allows the freed-up processor cores of the RAN nodes 111 to perform, for example, other virtualized applications. In some implementations, an individual RAN node 111 may represent individual gNB distributed units (DUs) that are connected to a gNB central unit (CU) using individual F1 interfaces (not shown in FIG. 1). In some implementations, the gNB-DUs may include one or more remote radio heads or RFEMs (see, e.g., FIG. 4), and the gNB-CU may be operated by a server that is located in the RAN 110 (not shown) or by a server pool in a similar manner as the CRAN/vBBUP. Additionally or alternatively, one or more of the RAN nodes 111 may be next generation eNBs (ng-eNBs), including RAN nodes that provide E-UTRA user plane and control plane protocol terminations toward the UEs 101, and are connected to a 5G core network (e.g., core network 120) using a next generation interface.

In vehicle-to-everything (V2X) scenarios, one or more of the RAN nodes 111 may be or act as RSUs. The term “Road Side Unit” or “RSU” refers to any transportation infrastructure entity used for V2X communications. A RSU may be implemented in or by a suitable RAN node or a stationary (or relatively stationary) UE, where a RSU implemented in or by a UE may be referred to as a “UE-type RSU,” a RSU implemented in or by an eNB may be referred to as an “eNB-type RSU,” a RSU implemented in or by a gNB may be referred to as a “gNB-type RSU,” and the like. In some implementations, an RSU is a computing device coupled with radio frequency circuitry located on a roadside that provides connectivity support to passing vehicle UEs 101 (vUEs 101). The RSU may also include internal data storage circuitry to store intersection map geometry, traffic statistics, media, as well as applications or other software to sense and control ongoing vehicular and pedestrian traffic. The RSU may operate on the 5.9 GHz Direct Short Range Communications (DSRC) band to provide very low latency communications required for high speed events, such as crash avoidance, traffic warnings, and the like. Additionally or alternatively, the RSU may operate on the cellular V2X band to provide the aforementioned low latency communications, as well as other cellular communications services. Additionally or alternatively, the RSU may operate as a Wi-Fi hotspot (2.4 GHz band) or provide connectivity to one or more cellular networks to provide uplink and downlink communications, or both. The computing device(s) and some or all of the radiofrequency circuitry of the RSU may be packaged in a weatherproof enclosure suitable for outdoor installation, and may include a network interface controller to provide a wired connection (e.g., Ethernet) to a traffic signal controller or a backhaul network, or both.

FIG. 4 illustrates an example of infrastructure equipment 400. The infrastructure equipment 400 (or “system 400”) may be implemented as a base station, a radio head, a RAN node, such as the RAN nodes 111 shown and described previously, an application server 130, or any other component or device described herein. In other examples, the system 400 can be implemented in or by a UE.

The system 400 includes application circuitry 405, baseband circuitry 410, one or more radio front end modules (RFEMs) 415, memory circuitry 420, power management integrated circuitry (PMIC) 425, power tee circuitry 430, network controller circuitry 435, network interface connector 440, satellite positioning circuitry 445, and user interface circuitry 450. In some implementations, the system 400 may include additional elements such as, for example, memory, storage, a display, a camera, one or more sensors, or an input/output (I/O) interface, or combinations of them, among others. In other examples, the components described with reference to the system 400 may be included in more than one device. For example, the various circuitries may be separately included in more than one device for CRAN, vBBU, or other implementations.

The application circuitry 405 includes circuitry such as, but not limited to, one or more processors (or processor cores), cache memory, one or more of low drop-out voltage regulators (LDOs), interrupt controllers, serial interfaces such as SPI, I2C or universal programmable serial interface module, real time clock (RTC), timer-counters including interval and watchdog timers, general purpose input/output (I/O or IO), memory card controllers such as Secure Digital (SD), MultiMediaCard (MMC), Universal Serial Bus (USB) interfaces, Mobile Industry Processor Interface (MIPI) interfaces and Joint Test Access Group (JTAG) test access ports. The processors (or cores) of the application circuitry 405 may be coupled with or may include memory or storage elements and may be configured to execute instructions stored in the memory or storage to enable various applications or operating systems to run on the system 400. In some implementations, the memory or storage elements may include on-chip memory circuitry, which may include any suitable volatile or non-volatile memory, such as DRAM, SRAM, EPROM, EEPROM, Flash memory, solid-state memory, or combinations of them, among other types of memory.

The processor(s) of the application circuitry 405 may include, for example, one or more processor cores (CPUs), one or more application processors, one or more graphics processing units (GPUs), one or more reduced instruction set computing (RISC) processors, one or more complex instruction set computing (CISC) processors, one or more digital signal processors (DSP), one or more FPGAs, one or more PLDs, one or more ASICs, one or more microprocessors or controllers, or combinations of them, among others. In some implementations, the application circuitry 405 may include, or may be, a special-purpose processor or controller configured to carry out the various techniques described here. In some implementations, the system 400 may not utilize application circuitry 405, and instead may include a special-purpose processor or controller to process IP data received from an EPC or 5GC, for example.

In some implementations, the application circuitry 405 may include one or more hardware accelerators, which may be microprocessors, programmable processing devices, or the like. The one or more hardware accelerators may include, for example, computer vision (CV) or deep learning (DL) accelerators, or both. In some implementations, the programmable processing devices may be one or more a field-programmable devices (FPDs) such as field-programmable gate arrays (FPGAs) and the like; programmable logic devices (PLDs) such as complex PLDs (CPLDs) or high-capacity PLDs (HCPLDs); ASICs such as structured ASICs; programmable SoCs (PSoCs), or combinations of them, among others. In such implementations, the circuitry of application circuitry 405 may include logic blocks or logic fabric, and other interconnected resources that may be programmed to perform various functions, such as the procedures, methods, functions described herein. In some implementations, the circuitry of application circuitry 405 may include memory cells (e.g., erasable programmable read-only memory (EPROM), electrically erasable programmable read-only memory (EEPROM), flash memory, static memory (e.g., static random access memory (SRAM) or anti-fuses)) used to store logic blocks, logic fabric, data, or other data in look-up-tables (LUTs) and the like.

The user interface circuitry 450 may include one or more user interfaces designed to enable user interaction with the system 400 or peripheral component interfaces designed to enable peripheral component interaction with the system 400. User interfaces may include, but are not limited to, one or more physical or virtual buttons (e.g., a reset button), one or more indicators (e.g., light emitting diodes (LEDs)), a physical keyboard or keypad, a mouse, a touchpad, a touchscreen, speakers or other audio emitting devices, microphones, a printer, a scanner, a headset, a display screen or display device, or combinations of them, among others. Peripheral component interfaces may include, but are not limited to, a nonvolatile memory port, a universal serial bus (USB) port, an audio jack, a power supply interface, among others.

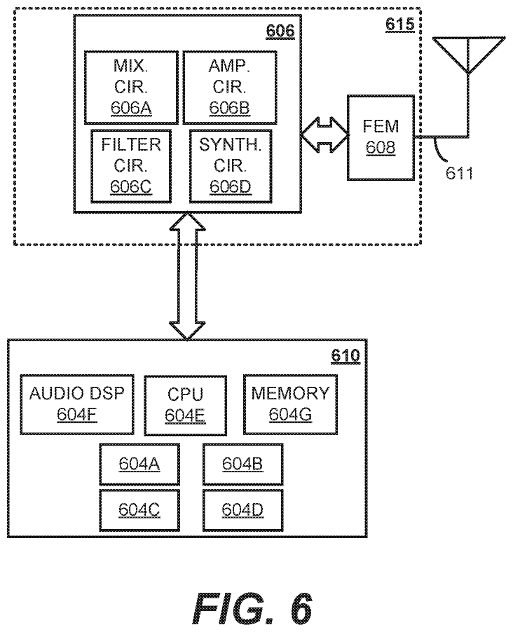

The radio front end modules (RFEMs) 415 may include a millimeter wave (mmWave) RFEM and one or more sub-mmWave radio frequency integrated circuits (RFICs). In some implementations, the one or more sub-mmWave RFICs may be physically separated from the mmWave RFEM. The RFICs may include connections to one or more antennas or antenna arrays (see, e.g., antenna array 611 of FIG. 6), and the RFEM may be connected to multiple antennas. In some implementations, both mmWave and sub-mmWave radio functions may be implemented in the same physical RFEM 415, which incorporates both mmWave antennas and sub-mmWave. The baseband circuitry 410 may be implemented, for example, as a solder-down substrate including one or more integrated circuits, a single packaged integrated circuit soldered to a main circuit board or a multi-chip module containing two or more integrated circuits.

The memory circuitry 420 may include one or more of volatile memory, such as dynamic random access memory (DRAM) or synchronous dynamic random access memory (SDRAM), and nonvolatile memory (NVM), such as high-speed electrically erasable memory (commonly referred to as Flash memory), phase change random access memory (PRAM), or magnetoresistive random access memory (MRAM), or combinations of them, among others. Memory circuitry 420 may be implemented as one or more of solder down packaged integrated circuits, socketed memory modules and plug-in memory cards, for example.

The PMIC 425 may include voltage regulators, surge protectors, power alarm detection circuitry, and one or more backup power sources such as a battery or capacitor. The power alarm detection circuitry may detect one or more of brown out (under-voltage) and surge (over-voltage) conditions. The power tee circuitry 430 may provide for electrical power drawn from a network cable to provide both power supply and data connectivity to the infrastructure equipment 400 using a single cable.

The network controller circuitry 435 may provide connectivity to a network using a standard network interface protocol such as Ethernet, Ethernet over GRE Tunnels, Ethernet over Multiprotocol Label Switching (MPLS), or some other suitable protocol. Network connectivity may be provided to and from the infrastructure equipment 400 using network interface connector 440 using a physical connection, which may be electrical (commonly referred to as a “copper interconnect”), optical, or wireless. The network controller circuitry 435 may include one or more dedicated processors or FPGAs, or both, to communicate using one or more of the aforementioned protocols. In some implementations, the network controller circuitry 435 may include multiple controllers to provide connectivity to other networks using the same or different protocols.

The positioning circuitry 445 includes circuitry to receive and decode signals transmitted or broadcasted by a positioning network of a global navigation satellite system (GNSS). Examples of a GNSS include United States' Global Positioning System (GPS), Russia's Global Navigation System (GLONASS), the European Union's Galileo system, China's BeiDou Navigation Satellite System, a regional navigation system or GNSS augmentation system (e.g., Navigation with Indian Constellation (NAVIC), Japan's Quasi-Zenith Satellite System (QZSS), France's Doppler Orbitography and Radio-positioning Integrated by Satellite (DORIS)), among other systems. The positioning circuitry 445 can include various hardware elements (e.g., including hardware devices such as switches, filters, amplifiers, antenna elements, and the like to facilitate OTA communications) to communicate with components of a positioning network, such as navigation satellite constellation nodes. In some implementations, the positioning circuitry 445 may include a Micro-Technology for Positioning, Navigation, and Timing (Micro-PNT) IC that uses a master timing clock to perform position tracking and estimation without GNSS assistance. The positioning circuitry 445 may also be part of, or interact with, the baseband circuitry 410 or RFEMs 415, or both, to communicate with the nodes and components of the positioning network. The positioning circuitry 445 may also provide data (e.g., position data, time data) to the application circuitry 405, which may use the data to synchronize operations with various infrastructure (e.g., RAN nodes 111).

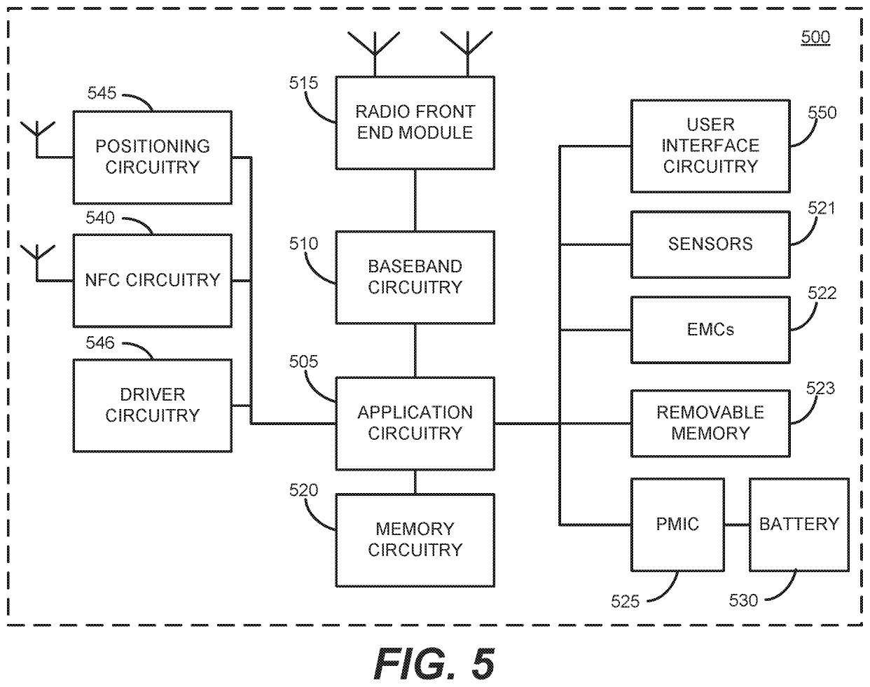

FIG. 5 illustrates an example of a platform 500 (or “device 500”). In some implementations, the computer platform 500 may be suitable for use as UEs 101, 201, 301, application servers 130, or any other component or device discussed herein. The platform 500 may include any combinations of the components shown in the example. The components of platform 500 (or portions thereof) may be implemented as integrated circuits (ICs), discrete electronic devices, or other modules, logic, hardware, software, firmware, or a combination of them adapted in the computer platform 500, or as components otherwise incorporated within a chassis of a larger system. The block diagram of FIG. 5 is intended to show a high level view of components of the platform 500. However, in some implementations, the platform 500 may include fewer, additional, or alternative components, or a different arrangement of the components shown in FIG. 5.

The application circuitry 505 includes circuitry such as, but not limited to, one or more processors (or processor cores), cache memory, and one or more of LDOs, interrupt controllers, serial interfaces such as SPI, I2C or universal programmable serial interface module, RTC, timer-counters including interval and watchdog timers, general purpose I/O, memory card controllers such as SD MMC or similar, USB interfaces, MIPI interfaces, and JTAG test access ports. The processors (or cores) of the application circuitry 505 may be coupled with or may include memory/storage elements and may be configured to execute instructions stored in the memory or storage to enable various applications or operating systems to run on the system 500. In some implementations, the memory or storage elements may be on-chip memory circuitry, which may include any suitable volatile or non-volatile memory, such as DRAM, SRAM, EPROM, EEPROM, Flash memory, solid-state memory, or combinations of them, among other types of memory.

The processor(s) of application circuitry 505 may include, for example, one or more processor cores, one or more application processors, one or more GPUs, one or more RISC processors, one or more ARM processors, one or more CISC processors, one or more DSP, one or more FPGAs, one or more PLDs, one or more ASICs, one or more microprocessors or controllers, a multithreaded processor, an ultra-low voltage processor, an embedded processor, some other known processing element, or any suitable combination thereof. In some implementations, the application circuitry 405 may include, or may be, a special-purpose processor/controller to carry out the techniques described herein. In some implementations, the application circuitry 505 may be a part of a system on a chip (SoC) in which the application circuitry 505 and other components are formed into a single integrated circuit, or a single package.

In some implementations, the application circuitry 505 may include circuitry such as, but not limited to, one or more a field-programmable devices (FPDs) such as FPGAs; PLDs such as CPLDs, HCPLDs; ASICs such as structured ASICs; PSoCs, or combinations of them, among others. In some implementations, the application circuitry 505 may include logic blocks or logic fabric, and other interconnected resources that may be programmed to perform various functions, such as the procedures, methods, functions described herein. In some implementations, the application circuitry 505 may include memory cells e.g., EPROM, EEPROM, flash memory, static memory such as SRAM or anti-fuses, used to store logic blocks, logic fabric, data, or other data in LUTs and the like.

The baseband circuitry 510 may be implemented, for example, as a solder-down substrate including one or more integrated circuits, a single packaged integrated circuit soldered to a main circuit board or a multi-chip module containing two or more integrated circuits. The various hardware electronic elements of baseband circuitry 510 are discussed with regard to FIG. 6.

The RFEMs 515 can include a millimeter wave (mmWave) RFEM and one or more sub-mmWave RFICs. In some implementations, the one or more sub-mmWave RFICs may be physically separated from the mmWave RFEM. The RFICs may include connections to one or more antennas or antenna arrays (see, e.g., antenna array 611 of FIG. 6), and the RFEM may be connected to multiple antennas. In some implementations, both mmWave and sub-mmWave radio functions may be implemented in the same physical RFEM 515, which incorporates both mmWave antennas and sub-mmWave. In some implementations, the RFEMs 515, the baseband circuitry 510, or both are included in a transceiver of the platform 500.

The memory circuitry 520 may include any number and type of memory devices used to provide for a given amount of system memory. As examples, the memory circuitry 520 may include one or more of volatile memory, such as RAM, DRAM, or SDRAM, and NVM, such as high-speed electrically erasable memory (commonly referred to as Flash memory), PRAM, or MRAM, or combinations of them, among others. In low power implementations, the memory circuitry 520 may be on-die memory or registers associated with the application circuitry 505. To provide for persistent storage of information such as data, applications, operating systems and so forth, memory circuitry 520 may include one or more mass storage devices, which may include, for example, a solid state drive (SSD), hard disk drive (HDD), a micro HDD, resistance change memories, phase change memories, holographic memories, or chemical memories, among others.

The removable memory circuitry 523 may include devices, circuitry, enclosures, housings, ports or receptacles, among others, used to couple portable data storage devices with the platform 500. These portable data storage devices may be used for mass storage purposes, and may include, for example, flash memory cards (e.g., Secure Digital (SD) cards, microSD cards, xD picture cards), and USB flash drives, optical discs, or external HDDs, or combinations of them, among others. The platform 500 may also include interface circuitry (not shown) for connecting external devices with the platform 500. The external devices connected to the platform 500 using the interface circuitry include sensor circuitry 521 and electro-mechanical components (EMCs) 522, as well as removable memory devices coupled to removable memory circuitry 523.

The sensor circuitry 521 include devices, modules, or subsystems whose purpose is to detect events or changes in its environment and send the information (e.g., sensor data) about the detected events to one or more other devices, modules, or subsystems. Examples of such sensors include inertial measurement units (IMUs) such as accelerometers, gyroscopes, or magnetometers; microelectromechanical systems (MEMS) or nanoelectromechanical systems (NEMS) including 3-axis accelerometers, 3-axis gyroscopes, or magnetometers; level sensors; flow sensors; temperature sensors (e.g., thermistors); pressure sensors; barometric pressure sensors; gravimeters; altimeters; image capture devices (e.g., cameras or lensless apertures); light detection and ranging (LiDAR) sensors; proximity sensors (e.g., infrared radiation detector and the like), depth sensors, ambient light sensors, ultrasonic transceivers; microphones or other audio capture devices, or combinations of them, among others.

The EMCs 522 include devices, modules, or subsystems whose purpose is to enable the platform 500 to change its state, position, or orientation, or move or control a mechanism, system, or subsystem. Additionally, the EMCs 522 may be configured to generate and send messages or signaling to other components of the platform 500 to indicate a current state of the EMCs 522. Examples of the EMCs 522 include one or more power switches, relays, such as electromechanical relays (EMRs) or solid state relays (SSRs), actuators (e.g., valve actuators), an audible sound generator, a visual warning device, motors (e.g., DC motors or stepper motors), wheels, thrusters, propellers, claws, clamps, hooks, or combinations of them, among other electro-mechanical components. In some implementations, the platform 500 is configured to operate one or more EMCs 522 based on one or more captured events, instructions, or control signals received from a service provider or clients, or both.

In some implementations, the interface circuitry may connect the platform 500 with positioning circuitry 545. The positioning circuitry 545 includes circuitry to receive and decode signals transmitted or broadcasted by a positioning network of a GNSS. The positioning circuitry 545 comprises various hardware elements (e.g., including hardware devices such as switches, filters, amplifiers, antenna elements, and the like to facilitate OTA communications) to communicate with components of a positioning network, such as navigation satellite constellation nodes. In some implementations, the positioning circuitry 545 may include a Micro-PNT IC that uses a master timing clock to perform position tracking or estimation without GNSS assistance. The positioning circuitry 545 may also be part of, or interact with, the baseband circuitry 510 or RFEMs 515, or both, to communicate with the nodes and components of the positioning network. The positioning circuitry 545 may also provide data (e.g., position data, time data) to the application circuitry 505, which may use the data to synchronize operations with various infrastructure (e.g., radio base stations), for turn-by-turn navigation applications, or the like.

In some implementations, the interface circuitry may connect the platform 500 with Near-Field Communication (NFC) circuitry 540. The NFC circuitry 540 is configured to provide contactless, short-range communications based on radio frequency identification (RFID) standards, in which magnetic field induction is used to enable communication between NFC circuitry 540 and NFC-enabled devices external to the platform 500 (e.g., an “NFC touchpoint”). The NFC circuitry 540 includes an NFC controller coupled with an antenna element and a processor coupled with the NFC controller. The NFC controller may be a chip or IC providing NFC functionalities to the NFC circuitry 540 by executing NFC controller firmware and an NFC stack. The NFC stack may be executed by the processor to control the NFC controller, and the NFC controller firmware may be executed by the NFC controller to control the antenna element to emit short-range RF signals. The RF signals may power a passive NFC tag (e.g., a microchip embedded in a sticker or wristband) to transmit stored data to the NFC circuitry 540, or initiate data transfer between the NFC circuitry 540 and another active NFC device (e.g., a smartphone or an NFC-enabled POS terminal) that is proximate to the platform 500.

The driver circuitry 546 may include software and hardware elements that operate to control particular devices that are embedded in the platform 500, attached to the platform 500, or otherwise communicatively coupled with the platform 500. The driver circuitry 546 may include individual drivers allowing other components of the platform 500 to interact with or control various input/output (I/O) devices that may be present within, or connected to, the platform 500. For example, the driver circuitry 546 may include a display driver to control and allow access to a display device, a touchscreen driver to control and allow access to a touchscreen interface of the platform 500, sensor drivers to obtain sensor readings of sensor circuitry 521 and control and allow access to sensor circuitry 521, EMC drivers to obtain actuator positions of the EMCs 522 or control and allow access to the EMCs 522, a camera driver to control and allow access to an embedded image capture device, audio drivers to control and allow access to one or more audio devices.

The power management integrated circuitry (PMIC) 525 (also referred to as “power management circuitry 525”) may manage power provided to various components of the platform 500. In particular, with respect to the baseband circuitry 510, the PMIC 525 may control power-source selection, voltage scaling, battery charging, or DC-to-DC conversion. The PMIC 525 may be included when the platform 500 is capable of being powered by a battery 530, for example, when the device is included in a UE 101, 201, 301.

In some implementations, the PMIC 525 may control, or otherwise be part of, various power saving mechanisms of the platform 500. For example, if the platform 500 is in an RRC_CONNECTED state, where it is still connected to the RAN node as it expects to receive traffic shortly, then it may enter a state known as Discontinuous Reception Mode (DRX) after a period of inactivity. During this state, the platform 500 may power down for brief intervals of time and thus save power. If there is no data traffic activity for an extended period of time, then the platform 500 may transition off to an RRC_IDLE state, where it disconnects from the network and does not perform operations such as channel quality feedback or handover. This can allow the platform 500 to enter a very low power state, where it periodically wakes up to listen to the network and then powers down again. In some implementations, the platform 500 may not receive data in the RRC_IDLE state and instead must transition back to RRC_CONNECTED state to receive data. An additional power saving mode may allow a device to be unavailable to the network for periods longer than a paging interval (ranging from seconds to a few hours). During this time, the device may be unreachable to the network and may power down completely. Any data sent during this time may incurs a large delay and it is assumed the delay is acceptable.

A battery 530 may power the platform 500, although in some implementations the platform 500 may be deployed in a fixed location, and may have a power supply coupled to an electrical grid. The battery 530 may be a lithium ion battery, a metal-air battery, such as a zinc-air battery, an aluminum-air battery, or a lithium-air battery, among others. In some implementations, such as in V2X applications, the battery 530 may be a typical lead-acid automotive battery.

The user interface circuitry 550 includes various input/output (I/O) devices present within, or connected to, the platform 500, and includes one or more user interfaces designed to enable user interaction with the platform 500 or peripheral component interfaces designed to enable peripheral component interaction with the platform 500. The user interface circuitry 550 includes input device circuitry and output device circuitry. Input device circuitry includes any physical or virtual means for accepting an input including one or more physical or virtual buttons (e.g., a reset button), a physical keyboard, keypad, mouse, touchpad, touchscreen, microphones, scanner, or headset, or combinations of them, among others. The output device circuitry includes any physical or virtual means for showing information or otherwise conveying information, such as sensor readings, actuator position(s), or other information. Output device circuitry may include any number or combinations of audio or visual display, including one or more simple visual outputs or indicators (e.g., binary status indicators (e.g., light emitting diodes (LEDs)), multi-character visual outputs, or more complex outputs such as display devices or touchscreens (e.g., Liquid Crystal Displays (LCD), LED displays, quantum dot displays, or projectors), with the output of characters, graphics, or multimedia objects being generated or produced from the operation of the platform 500. The output device circuitry may also include speakers or other audio emitting devices, or printer(s). In some implementations, the sensor circuitry 521 may be used as the input device circuitry (e.g., an image capture device or motion capture device), and one or more EMCs may be used as the output device circuitry (e.g., an actuator to provide haptic feedback). In another example, NFC circuitry comprising an NFC controller coupled with an antenna element and a processing device may be included to read electronic tags or connect with another NFC-enabled device. Peripheral component interfaces may include, but are not limited to, a non-volatile memory port, a USB port, an audio jack, or a power supply interface.

FIG. 6 illustrates example components of baseband circuitry 610 and radio front end modules (RFEM) 615. The baseband circuitry 610 can correspond to the baseband circuitry 410 and 510 of FIGS. 4 and 5, respectively. The RFEM 615 can correspond to the RFEM 415 and 515 of FIGS. 4 and 5, respectively. As shown, the RFEMs 615 may include Radio Frequency (RF) circuitry 606, front-end module (FEM) circuitry 608, and antenna array 611 coupled together. In some implementations, the RFEMs 615, the baseband circuitry 610, or both are included in a transceiver.

The baseband circuitry 610 includes circuitry configured to carry out various radio or network protocol and control functions that enable communication with one or more radio networks using the RF circuitry 606. The radio control functions may include, but are not limited to, signal modulation and demodulation, encoding and decoding, and radio frequency shifting. In some implementations, modulation and demodulation circuitry of the baseband circuitry 610 may include Fast-Fourier Transform (FFT), precoding, or constellation mapping and demapping functionality. In some implementations, encoding and decoding circuitry of the baseband circuitry 610 may include convolution, tail-biting convolution, turbo, Viterbi, or Low Density Parity Check (LDPC) encoder and decoder functionality. Modulation and demodulation and encoder and decoder functionality are not limited to these examples and may include other suitable functionality in other examples. The baseband circuitry 610 is configured to process baseband signals received from a receive signal path of the RF circuitry 606 and to generate baseband signals for a transmit signal path of the RF circuitry 606. The baseband circuitry 610 is configured to interface with application circuitry (e.g., the application circuitry 405, 505 shown in FIGS. 4 and 5) for generation and processing of the baseband signals and for controlling operations of the RF circuitry 606. The baseband circuitry 610 may handle various radio control functions.

The aforementioned circuitry and control logic of the baseband circuitry 610 may include one or more single or multi-core processors. For example, the one or more processors may include a 3G baseband processor 604A, a 4G or LTE baseband processor 604B, a 5G or NR baseband processor 604C, or some other baseband processor(s) 604D for other existing generations, generations in development or to be developed in the future (e.g., sixth generation (6G)). In some implementations, some or all of the functionality of baseband processors 604A-D may be included in modules stored in the memory 604G and executed using one or more processors such as a Central Processing Unit (CPU) 604E. In some implementations, some or all of the functionality of baseband processors 604A-D may be provided as hardware accelerators (e.g., FPGAs or ASICs) loaded with the appropriate bit streams or logic blocks stored in respective memory cells. In some implementations, the memory 604G may store program code of a real-time OS (RTOS) which, when executed by the CPU 604E (or other processor), is to cause the CPU 604E (or other processor) to manage resources of the baseband circuitry 610, schedule tasks, or carry out other operations. In some implementations, the baseband circuitry 610 includes one or more audio digital signal processors (DSP) 604F. An audio DSP 604F can include elements for compression and decompression and echo cancellation and may include other suitable processing elements in some implementations.

In some implementations, each of the processors 604A-604E includes respective memory interfaces to send and receive data to and from the memory 604G. The baseband circuitry 610 may further include one or more interfaces to communicatively couple to other circuitries or devices, such as an interface to send and receive data to and from memory external to the baseband circuitry 610; an application circuitry interface to send and receive data to and from the application circuitry 405, 505 of FIGS. 4 and 5); an RF circuitry interface to send and receive data to and from RF circuitry 606 of FIG. 6; a wireless hardware connectivity interface to send and receive data to and from one or more wireless hardware elements (e.g., Near Field Communication (NFC) components, Bluetooth®/Bluetooth® Low Energy components, Wi-Fi components, and/or the like); and a power management interface to send and receive power or control signals to and from the PMIC 525.

In some implementations (which may be combined with the above described examples), the baseband circuitry 610 includes one or more digital baseband systems, which are coupled with one another using an interconnect subsystem and to a CPU subsystem, an audio subsystem, and an interface subsystem. The digital baseband subsystems may also be coupled to a digital baseband interface and a mixed-signal baseband subsystem using another interconnect subsystem. Each of the interconnect subsystems may include a bus system, point-to-point connections, network-on-chip (NOC) structures, or some other suitable bus or interconnect technology, such as those discussed herein. The audio subsystem may include DSP circuitry, buffer memory, program memory, speech processing accelerator circuitry, data converter circuitry such as analog-to-digital and digital-to-analog converter circuitry, analog circuitry including one or more of amplifiers and filters, among other components. In some implementations, the baseband circuitry 610 may include protocol processing circuitry with one or more instances of control circuitry (not shown) to provide control functions for the digital baseband circuitry or radio frequency circuitry (e.g., the radio front end modules 615).

In some implementations, the baseband circuitry 610 includes individual processing device(s) to operate one or more wireless communication protocols (e.g., a “multi-protocol baseband processor” or “protocol processing circuitry”) and individual processing device(s) to implement PHY layer functions. In some implementations, the PHY layer functions include the aforementioned radio control functions. In some implementations, the protocol processing circuitry operates or implements various protocol layers or entities of one or more wireless communication protocols. For example, the protocol processing circuitry may operate LTE protocol entities or 5G NR protocol entities, or both, when the baseband circuitry 610 or RF circuitry 606, or both, are part of mmWave communication circuitry or some other suitable cellular communication circuitry. In this example, the protocol processing circuitry can operate MAC, RLC, PDCP, SDAP, RRC, and NAS functions. In some implementations, the protocol processing circuitry may operate one or more IEEE-based protocols when the baseband circuitry 610 or RF circuitry 606, or both, are part of a Wi-Fi communication system. In this example, the protocol processing circuitry can operate Wi-Fi MAC and logical link control (LLC) functions. The protocol processing circuitry may include one or more memory structures (e.g., 604G) to store program code and data for operating the protocol functions, as well as one or more processing cores to execute the program code and perform various operations using the data. The baseband circuitry 610 may also support radio communications for more than one wireless protocol.

The various hardware elements of the baseband circuitry 610 discussed herein may be implemented, for example, as a solder-down substrate including one or more integrated circuits (ICs), a single packaged IC soldered to a main circuit board or a multi-chip module containing two or more ICs. In some implementations, the components of the baseband circuitry 610 may be suitably combined in a single chip or chipset, or disposed on a same circuit board. In some implementations, some or all of the constituent components of the baseband circuitry 610 and RF circuitry 606 may be implemented together such as, for example, a system on a chip (SoC) or System-in-Package (SiP). In some implementations, some or all of the constituent components of the baseband circuitry 610 may be implemented as a separate SoC that is communicatively coupled with and RF circuitry 606 (or multiple instances of RF circuitry 606). In some implementations, some or all of the constituent components of the baseband circuitry 610 and the application circuitry 405, 505 may be implemented together as individual SoCs mounted to a same circuit board (e.g., a “multi-chip package”).

In some implementations, the baseband circuitry 610 may provide for communication compatible with one or more radio technologies. The RF circuitry 606 may enable communication with wireless networks using modulated electromagnetic radiation through a non-solid medium. In some implementations, the RF circuitry 606 may include switches, filters, or amplifiers, among other components, to facilitate the communication with the wireless network. The RF circuitry 606 may include a receive signal path, which may include circuitry to down-convert RF signals received from the FEM circuitry 608 and provide baseband signals to the baseband circuitry 610. The RF circuitry 606 may also include a transmit signal path, which may include circuitry to up-convert baseband signals provided by the baseband circuitry 610 and provide RF output signals to the FEM circuitry 608 for transmission.

The receive signal path of the RF circuitry 606 includes mixer circuitry 606a, amplifier circuitry 606b and filter circuitry 606c. In some implementations, the transmit signal path of the RF circuitry 606 may include filter circuitry 606c and mixer circuitry 606a. The RF circuitry 606 also includes synthesizer circuitry 606d for synthesizing a frequency for use by the mixer circuitry 606a of the receive signal path and the transmit signal path. In some implementations, the mixer circuitry 606a of the receive signal path may be configured to down-convert RF signals received from the FEM circuitry 608 based on the synthesized frequency provided by synthesizer circuitry 606d. The amplifier circuitry 606b may be configured to amplify the down-converted signals and the filter circuitry 606c may be a low-pass filter (LPF) or band-pass filter (BPF) configured to remove unwanted signals from the down-converted signals to generate output baseband signals. Output baseband signals may be provided to the baseband circuitry 610 for further processing. In some implementations, the output baseband signals may be zero-frequency baseband signals, although this is not a requirement. In some implementations, the mixer circuitry 606a of the receive signal path can include passive mixers.

In some implementations, the mixer circuitry 606a of the transmit signal path may be configured to up-convert input baseband signals based on the synthesized frequency provided by the synthesizer circuitry 606d to generate RF output signals for the FEM circuitry 608. The baseband signals may be provided by the baseband circuitry 610 and may be filtered by filter circuitry 606c.

In some implementations, the mixer circuitry 606a of the receive signal path and the mixer circuitry 606a of the transmit signal path may include two or more mixers and may be arranged for quadrature downconversion and upconversion, respectively. In some implementations, the mixer circuitry 606a of the receive signal path and the mixer circuitry 606a of the transmit signal path may include two or more mixers and may be arranged for image rejection (e.g., Hartley image rejection). In some implementations, the mixer circuitry 606a of the receive signal path and the mixer circuitry 606a of the transmit signal path may be arranged for direct downconversion and direct upconversion, respectively. In some implementations, the mixer circuitry 606a of the receive signal path and the mixer circuitry 606a of the transmit signal path may be configured for super-heterodyne operation.

In some implementations, the output baseband signals and the input baseband signals may be analog baseband signals. In some implementations, the output baseband signals and the input baseband signals may be digital baseband signals, and the RF circuitry 606 may include analog-to-digital converter (ADC) and digital-to-analog converter (DAC) circuitry and the baseband circuitry 610 may include a digital baseband interface to communicate with the RF circuitry 606. In some dual-mode examples, a separate radio IC circuitry may be provided for processing signals for each spectrum, although the techniques described here are not limited in this respect.

In some implementations, the synthesizer circuitry 606d may be a fractional-N synthesizer or a fractional N/N+1 synthesizer, although other types of frequency synthesizers may be used. For example, synthesizer circuitry 606d may be a delta-sigma synthesizer, a frequency multiplier, or a synthesizer comprising a phase-locked loop with a frequency divider. The synthesizer circuitry 606d may be configured to synthesize an output frequency for use by the mixer circuitry 606a of the RF circuitry 606 based on a frequency input and a divider control input. In some implementations, the synthesizer circuitry 606d may be a fractional N/N+1 synthesizer.

In some implementations, frequency input may be provided by a voltage controlled oscillator (VCO), although that is not a requirement. Divider control input may be provided by either the baseband circuitry 610 or the application circuitry 405/505 depending on the desired output frequency. In some implementations, a divider control input (e.g., N) may be determined from a look-up table based on a channel indicated by the application circuitry 405, 505.

The synthesizer circuitry 606d of the RF circuitry 606 may include a divider, a delay-locked loop (DLL), a multiplexer and a phase accumulator. In some implementations, the divider may be a dual modulus divider (DMD) and the phase accumulator may be a digital phase accumulator (DPA). In some implementations, the DMD may be configured to divide the input signal by either N or N+1 (e.g., based on a carry out) to provide a fractional division ratio. In some implementations, the DLL may include a set of cascaded, tunable, delay elements, a phase detector, a charge pump and a D-type flip-flop. The delay elements may be configured to break a VCO period up into Nd equal packets of phase, where Nd is the number of delay elements in the delay line. In this way, the DLL provides negative feedback to help ensure that the total delay through the delay line is one VCO cycle.

In some implementations, synthesizer circuitry 606d may be configured to generate a carrier frequency as the output frequency, while in other examples, the output frequency may be a multiple of the carrier frequency (e.g., twice the carrier frequency, four times the carrier frequency) and used in conjunction with quadrature generator and divider circuitry to generate multiple signals at the carrier frequency with multiple different phases with respect to each other. In some implementations, the output frequency may be a LO frequency (fLO). In some implementations, the RF circuitry 606 may include an IQ or polar converter.

The FEM circuitry 608 may include a receive signal path, which may include circuitry configured to operate on RF signals received from antenna array 611, amplify the received signals and provide the amplified versions of the received signals to the RF circuitry 606 for further processing. The FEM circuitry 608 may also include a transmit signal path, which may include circuitry configured to amplify signals for transmission provided by the RF circuitry 606 for transmission by one or more of antenna elements of antenna array 611. The amplification through the transmit or receive signal paths may be done solely in the RF circuitry 606, solely in the FEM circuitry 608, or in both the RF circuitry 606 and the FEM circuitry 608.

In some implementations, the FEM circuitry 608 may include a TX/RX switch to switch between transmit mode and receive mode operation. The FEM circuitry 608 may include a receive signal path and a transmit signal path. The receive signal path of the FEM circuitry 608 may include an LNA to amplify received RF signals and provide the amplified received RF signals as an output (e.g., to the RF circuitry 606). The transmit signal path of the FEM circuitry 608 may include a power amplifier (PA) to amplify input RF signals (e.g., provided by RF circuitry 606), and one or more filters to generate RF signals for subsequent transmission by one or more antenna elements of the antenna array 611.

The antenna array 611 includes one or more antenna elements, each of which is configured convert electrical signals into radio waves to travel through the air and to convert received radio waves into electrical signals. For example, digital baseband signals provided by the baseband circuitry 610 is converted into analog RF signals (e.g., modulated waveform) that will be amplified and transmitted using the antenna elements of the antenna array 611 including one or more antenna elements (not shown). The antenna elements may be omnidirectional, directional, or a combination thereof. The antenna elements may be formed in a multitude of arranges as are known and/or discussed herein. The antenna array 611 can include microstrip antennas or printed antennas that are fabricated on the surface of one or more printed circuit boards. The antenna array 611 may be formed as a patch of metal foil (e.g., a patch antenna) in a variety of shapes, and may be coupled with the RF circuitry 606 and/or FEM circuitry 608 using metal transmission lines or the like.

Processors of the application circuitry 405/505 and processors of the baseband circuitry 610 may be used to execute elements of one or more instances of a protocol stack. For example, processors of the baseband circuitry 610, alone or in combination, may execute Layer 3, Layer 2, or Layer 1 functionality, while processors of the application circuitry 405, 505 may utilize data (e.g., packet data) received from these layers and further execute Layer 4 functionality (e.g., TCP and UDP layers). As referred to herein, Layer 3 can include a RRC layer, described in further detail below. As referred to herein, Layer 2 can include a MAC layer, an RLC layer, and a PDCP layer, described in further detail below. As referred to herein, Layer 1 can include a PHY layer of a UE/RAN node, described in further detail below.

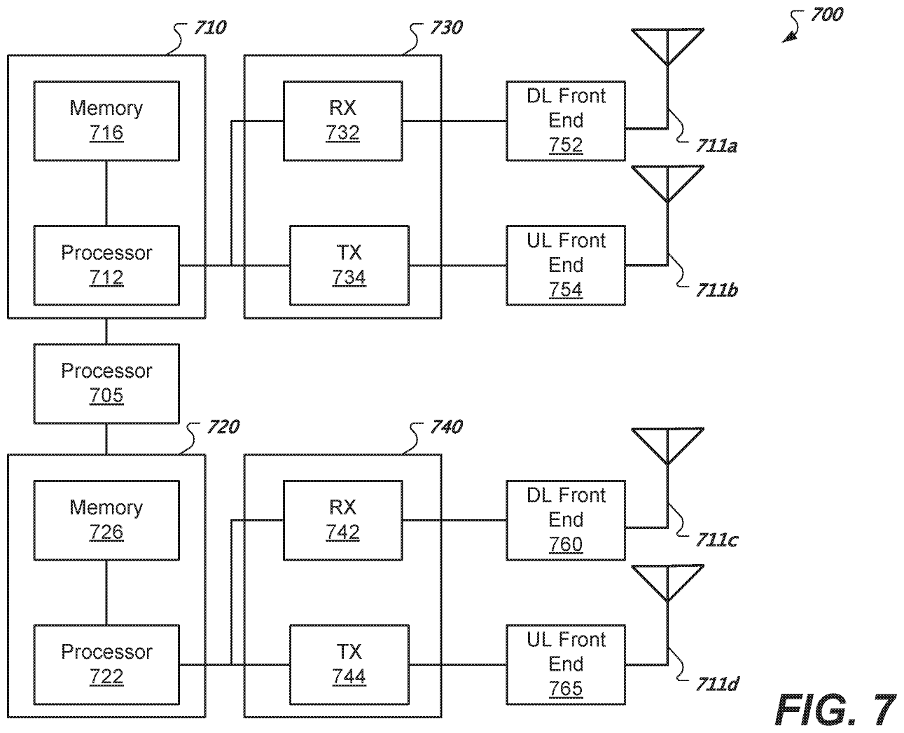

FIG. 7 illustrates example components of communication circuitry 700. In some implementations, the communication circuitry 700 may be implemented as part of the system 400 or the platform 500 shown in FIGS. 4 and 5. The communication circuitry 700 may be communicatively coupled (e.g., directly or indirectly) to one or more antennas, such as antennas 711a, 711b, 711c, and 711d. In some implementations, the communication circuitry 700 includes or is communicatively coupled to dedicated receive chains, processors, or radios, or combinations of them, for multiple RATs (e.g., a first receive chain for LTE and a second receive chain for 5G NR). For example, as shown in FIG. 7, the communication circuitry 700 includes a modem 710 and a modem 720, which may correspond to or be a part of the baseband circuitry 410 and 510 of FIGS. 4 and 5. The modem 710 may be configured for communications according to a first RAT, such as LTE or LTE-A, and the modem 720 may be configured for communications according to a second RAT, such as 5G NR. In some implementations, a processor 705, such as an application processor can interface with the modems 710, 720.

The modem 710 includes one or more processors 712 and a memory 716 in communication with the processors 712. The modem 710 is in communication with a radio frequency (RF) front end 730, which may correspond to or be a part of to the RFEM 415 and 515 of FIGS. 4 and 5. The RF front end 730 may include circuitry for transmitting and receiving radio signals. For example, the RF front end 730 includes RX circuitry 732 and TX circuitry 734. In some implementations, the receive circuitry 732 is in communication with a DL front end 752, which may include circuitry for receiving radio signals from one or more antennas 711a. The transmit circuitry 734 is in communication with a UL front end 754, which is coupled with one or more antennas 711b.

Similarly, the modem 720 includes one or more processors 722 and a memory 726 in communication with the one or more processors 722. The modem 720 is in communication with an RF front end 740, which may correspond to or be a part of to the RFEM 415 and 515 of FIGS. 4 and 5. The RF front end 740 may include circuitry for transmitting and receiving radio signals. For example, the RF front end 740 includes receive circuitry 742 and transmit circuitry 744. In some implementations, the receive circuitry 742 is in communication with a DL front end 760, which may include circuitry for receiving radio signals from one or more antennas 711c. The transmit circuitry 744 is in communication with a UL front end 765, which is coupled with one or more antennas 711d. In some implementations, one or more front-ends can be combined. For example, a RF switch can selectively couple the modems 710, 720 to a single UL front end 772 for transmitting radio signals using one or more antennas.

The modem 710 may include hardware and software components for time division multiplexing UL data (e.g., for NSA NR operations), as well as the various other techniques described herein. The processors 712 may include one or more processing elements configured to implement various features described herein, such as by executing program instructions stored on the memory 716 (e.g., a non-transitory computer-readable memory medium). In some implementations, the processor 712 may be configured as a programmable hardware element, such as a FPGA or an ASIC. In some implementations, the processors 712 may include one or more ICs that are configured to perform the functions of processors 712. For example, each IC may include circuitry configured to perform the functions of processors 712.

The modem 720 may include hardware and software components for time division multiplexing UL data (e.g., for NSA NR operations), as well as the various other techniques described herein. The processors 722 may include one or more processing elements configured to implement various features described herein, such as by executing instructions stored on the memory 726 (e.g., a non-transitory computer-readable memory medium). In some implementations, the processor 722 may be configured as a programmable hardware element, such as a FPGA or an ASIC. In some implementations, the processor 722 may include one or more ICs that are configured to perform the functions of processors 722.

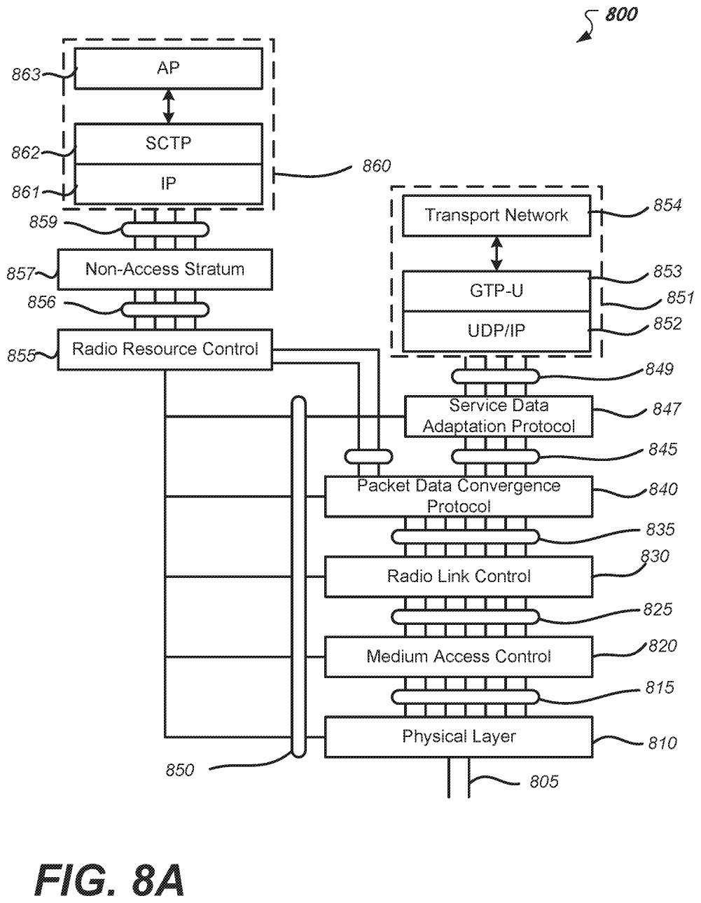

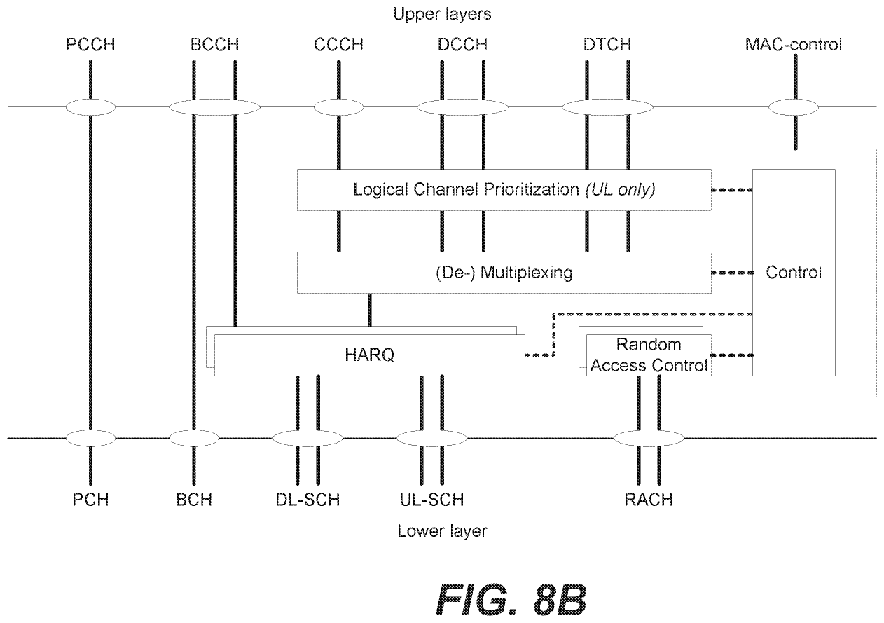

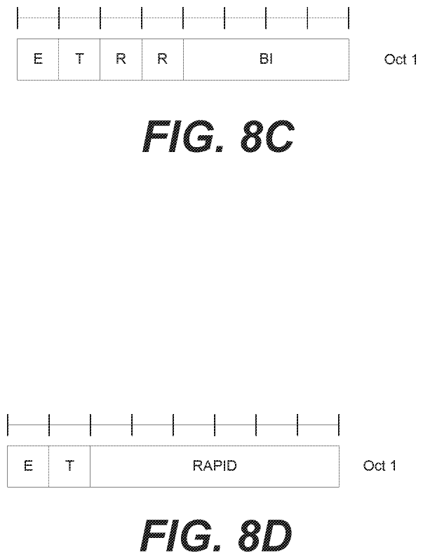

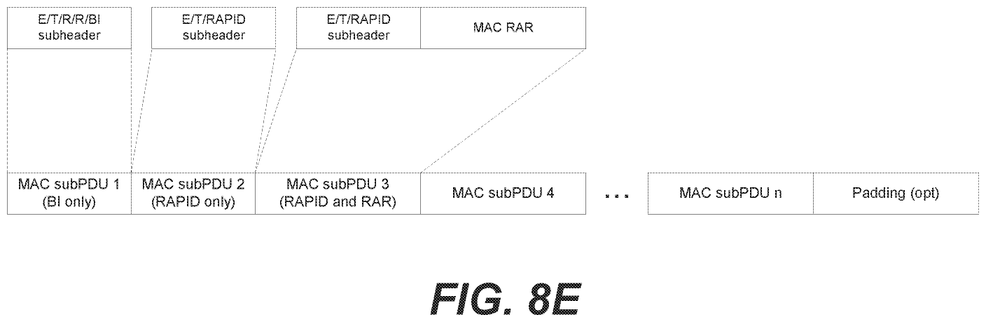

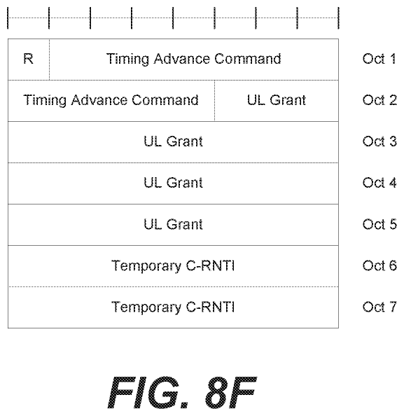

FIGS. 8A-8F illustrates various protocol functions including MAC functions that may be implemented in a wireless communication device. FIG. 8A illustrates various protocol functions that may be implemented in a wireless communication device. In particular, FIG. 8A includes an arrangement 800 showing interconnections between various protocol layers/entities. The following description of FIG. 8A is provided for various protocol layers/entities that operate in conjunction with the 5G/NR system standards and LTE system standards, but some or all of the aspects of FIG. 8A may be applicable to other wireless communication network systems as well.

The protocol layers of arrangement 800 may include one or more of PHY 810, MAC 820, RLC 830, PDCP 840, SDAP 847, RRC 855, and NAS layer 857, in addition to other higher layer functions not illustrated. The protocol layers may include one or more service access points (e.g., items 859, 856, 850, 849, 845, 835, 825, and 815 in FIG. 8A) that may provide communication between two or more protocol layers.

The PHY 810 may transmit and receive physical layer signals 805 that may be received from or transmitted to one or more other communication devices. The physical layer signals 805 can include one or more physical channels, such as those discussed herein. The PHY 810 may further perform link adaptation or adaptive modulation and coding (AMC), power control, cell search (e.g., for initial synchronization and handover purposes), and other measurements used by higher layers, such as the RRC 855. The PHY 810 may still further perform error detection on the transport channels, forward error correction (FEC) coding/decoding of the transport channels, modulation/demodulation of physical channels, interleaving, rate matching, mapping onto physical channels, and MIMO antenna processing. In embodiments, an instance of PHY 810 may process requests from and provide indications to an instance of MAC 820 via one or more PHY-SAP 815. In some implementations, requests and indications communicated via PHY-SAP 815 can include one or more transport channels.

Instance(s) of MAC 820 process requests from, and provide indications to, an instance of RLC 830 via one or more MAC-SAPs 825. These requests and indications communicated via the MAC-SAP 825 can include one or more logical channels. The MAC 820 may perform mapping between the logical channels and transport channels, multiplexing of MAC SDUs from one or more logical channels onto TBs to be delivered to PHY 810 via the transport channels, de-multiplexing MAC SDUs to one or more logical channels from TBs delivered from the PHY 810 via transport channels, multiplexing MAC SDUs onto TBs, scheduling information reporting, error correction through HARQ, and logical channel prioritization.

FIG. 8B illustrates an example of a structure of the MAC entity 820 when a secondary cell group (SCG) is not configured. Note that a similar structure may be used when SCG is configured. The MAC 820 entity of the UE 101 (and/or the RAN node 111) handles the following transport channels: Broadcast Channel (BCH); Downlink Shared Channel(s) (DL-SCH); Paging Channel (PCH); Uplink Shared Channel(s) (UL-SCH); and Random Access Channel(s) (RACH). When the UE 101 is configured with SCG, two MAC 820 entities are configured to the UE 101: one for the Master Cell Group (MCG) and one for the SCG. The functions of the different MAC 820 entities in the UE 101 operate independently unless otherwise specified. The timers and parameters used in each MAC 820 entity are configured independently unless otherwise specified. The Serving Cells, C-RNTI, radio bearers, logical channels, upper and lower layer entities, logical channel groups (LCGs), and HARQ entities considered by each MAC 820 entity refer to those mapped to that MAC 820 entity unless otherwise specified.

If the MAC 820 entity is configured with one or more secondary cells (SCells), there are multiple DL-SCH and there may be multiple UL-SCH as well as multiple RACH per MAC entity; one DL-SCH, one UL-SCH, and one RACH on the SpCell, one DL-SCH, zero or one UL-SCH and zero or one RACH for each SCell. If the MAC 820 entity is not configured with any SCell, there is one DL-SCH, one UL-SCH, and one RACH per MAC entity.

Additionally, instance(s) of the MAC 820 perform aspects of a random access procedure, including aspects of a 2-step or 4-step RACH procedure discussed herein. The random access procedure can be initiated by a PDCCH order, by the MAC entity 820 itself, or by RRC 855 for the events in accordance with 3GPP TS 38.300. The RRC 855 configures the parameters discussed in section 5.1.1 of 3GPP TS 38.321 for the random access procedure. In some implements, there is one random access procedure ongoing at any point in time in a MAC entity 820 instance. In some implementations, instance(s) of the MAC 820 select(s) random access resources according to section 5.1.2 of 3GPP TS 38.321, transmit(s) a random access preamble according to section 5.1.3 of 3GPP TS 38.321, and receive(s) a RAR according to section 5.1.4 of 3GPP TS 38.321. Instance(s) of the MAC 820 also performs various contention resolution operations according to section 5.1.5 of 3GPP TS 38.321.

Uplink grants can be received dynamically on the PDCCH, in a RAR, or configured semi-persistently by RRC 855. The MAC 820 entity uses the uplink grant to transmit on the UL-SCH. To perform the requested transmissions, the MAC 820 receives HARQ information from lower layers. If the MAC entity has a C-RNTI, a Temporary C-RNTI, or CS-RNTI, the MAC entity performs the operations of section 5.4.1 of 3GPP TS 38.321 for each PDCCH occasion and for each Serving Cell belonging to a TAG that has a running timeAlignmentTimer and for each grant received for that PDCCH occasion.

Instance(s) of the MAC 820 perform multiplexing and assembly operations. The MAC 820 entity multiplexes MAC CEs and MAC SDUs in a MAC PDU according to clauses 5.4.3.1 and 6.1.2 of 3GPP TS 38.321. The multiplexing and assembly operations include Logical Channel Prioritization (LCP). The LCP procedure is applied whenever a new transmission is performed. RRC 855 controls the scheduling of uplink data by signalling for each logical channel per MAC 820 entity: priority where an increasing priority value indicates a lower priority level; prioritisedBitRate which sets the Prioritized Bit Rate (PBR); and bucketSizeDuration which sets the Bucket Size Duration (BSD). RRC 855 additionally controls the LCP procedure by configuring mapping restrictions for each logical channel: allowedSCS-List which sets the allowed Subcarrier Spacing(s) for transmission; maxPUSCH-Duration which sets the maximum PUSCH duration allowed for transmission; configuredGrantType1Allowed which sets whether a configured grant Type 1 can be used for transmission; and allowedServingCells which sets the allowed cell(s) for transmission.

The UE variable Bj is used for the LCP procedure, which is maintained for each logical channel j. The MAC 820 entity initializes Bj of the logical channel to zero when the logical channel is established. For each logical channel j, the MAC 820 entity increments Bj by the product PBR×T before every instance of the LCP procedure, where T is the time elapsed since Bj was last incremented; and if the value of Bj is greater than the bucket size (e.g., PBR×BSD): the MAC 820 entity sets Bj to the bucket size. The exact moment(s) when the UE updates Bj between LCP procedures is up to UE implementation, as long as Bj is up to date at the time when a grant is processed by LCP.

The MAC 820 entity selects the logical channels for each UL grant when a new transmission is performed. Logical channels for each UL grant can be selected to satisfy the following conditions: the set of allowed Subcarrier Spacing index values in allowedSCS-List, if configured, includes the SCS index associated to the UL grant; and maxPUSCH-Duration, if configured, is larger than or equal to the PUSCH transmission duration associated to the UL grant; and configuredGrantType1Allowed, if configured, is set to true in case the UL grant is a Configured Grant Type 1; and allowedServingCells, if configured, includes the cell information associated to the UL grant. Does not apply to logical channels associated with a DRB configured with PDCP duplication within the same MAC entity (e.g., CA duplication) for which PDCP duplication is deactivated. The SCS index, PUSCH transmission duration and cell information are included in Uplink transmission information received from lower layers for the corresponding scheduled uplink transmission.

When a new transmission is performed, the MAC 820 entity allocates resources to the logical channels as follows. Logical channels selected in clause 5.4.3.1.2 of 3GPP TS 38.321 for the UL grant with Bj>0 are allocated resources in a decreasing priority order. If the PBR of a logical channel is set to infinity, the MAC entity shall allocate resources for all the data that is available for transmission on the logical channel before meeting the PBR of the lower priority logical channel(s). Next, the MAC 820 entity can decrement Bj by the total size of MAC SDUs served to logical channel j above (the value of Bj can be negative). If any resources remain, all the logical channels selected in clause 5.4.3.1.2 can be served in a strict decreasing priority order (regardless of the value of Bj) until either the data for that logical channel or the UL grant is exhausted, whichever comes first. Logical channels configured with equal priority can be served equally.

If the MAC 820 entity is requested to simultaneously transmit multiple MAC PDUs, or if the MAC 820 entity receives the multiple UL grants within one or more coinciding PDCCH occasions (e.g., on different Serving Cells), it is up to UE implementation in which order the grants are processed. The UE 101 (or the MAC 820 entity) also follows the rules below during the scheduling procedures discussed above: the UE 101 should not segment an RLC SDU (or partially transmitted SDU or retransmitted RLC PDU) if the whole SDU (or partially transmitted SDU or retransmitted RLC PDU) fits into the remaining resources of the associated MAC entity; if the UE 101 segments an RLC SDU from the logical channel, it can maximize the size of the segment to fill the grant of the associated MAC entity as much as possible; the UE 101 can maximize the transmission of data; and/or if the MAC 820 entity is given a UL grant size that is equal to or larger than 8 bytes while having data available and allowed (according to clause 5.4.3.1 of 3GPP TS 38.321) for transmission, the MAC entity can not transmit only padding BSR and/or padding.

In some implementations, the MAC 820 entity does not generate a MAC PDU for the HARQ entity if the following conditions are satisfied: the MAC 820 entity is configured with skipUplinkTxDynamic with value true and the grant indicated to the HARQ entity was addressed to a C-RNTI and is not included in MsgB of a 2-step Random Access Procedure, or the grant indicated to the HARQ entity is a configured uplink grant; there is no aperiodic CSI requested for this PUSCH transmission as specified in 3GPP TS 38.212; the MAC PDU includes zero MAC SDUs; and the MAC PDU includes the periodic Buffer Status Report (BSR) and there is no data available for any LCG, or the MAC PDU includes only the padding BSR. In some implementations, the MAC 820 entity generates a MAC PDU for the HARQ entity if the grant indicated to the HARQ entity is included in MsgB of the 2-step random access procedure.

Logical channels can be prioritized in accordance with the following order (highest priority listed first): C-RNTI MAC CE or data from UL-CCCH; Configured Grant Confirmation MAC CE; MAC CE for BSR, with exception of BSR included for padding; Single Entry PHR MAC CE or Multiple Entry PHR MAC CE; data from any Logical Channel, except data from UL-CCCH; MAC CE for Recommended bit rate query; MAC CE for BSR included for padding.

A MAC PDU includes one or more MAC subPDUs and optionally padding. Each MAC subPDU can include: a MAC subheader only (including padding); a MAC subheader and a MAC SDU; a MAC subheader and a MAC CE; or a MAC subheader and padding. Each MAC subPDU can include one of the following: a MAC subheader with Backoff Indicator only; MAC subheader with RAPID only (i.e. acknowledgment for SI request); or a MAC subheader with RAPID and MAC RAR.

FIG. 8C illustrates an example of a MAC subheader with Backoff Indicator (BI) that includes five header fields E/T/R/R/BI. A MAC subPDU with Backoff Indicator only is placed at the beginning of the MAC PDU, if included. ‘MAC subPDU(s) with RAPID only’ and ‘MAC subPDU(s) with RAPID and MAC RAR’ can be placed anywhere between MAC subPDU with Backoff Indicator only (if any) and padding (if any). FIG. 8D illustrates an example of a MAC subheader with RAPID that includes three header fields E/T/RAPID. Padding is placed at the end of the MAC PDU if present. Presence and length of padding is implicit based on TB size, size of MAC subPDU(s).

FIG. 8E illustrates an example of a MAC PDU that includes MAC RARs. The MAC subheader for a RAR includes one or more of the following fields (and the MAC subheader is octet aligned). The MAC subheader can include an extension (E) field which is a flag indicating if the MAC subPDU including this MAC subheader is the last MAC subPDU or not in the MAC PDU. The E field is set to “1” to indicate at least another MAC subPDU follows. The E field is set to “0” to indicate that the MAC subPDU including this MAC subheader is the last MAC subPDU in the MAC PDU.

The MAC subheader can include a Type (T) field which is a flag indicating whether the MAC subheader contains a Random Access Preamble ID or a Backoff Indicator. The T field is set to “0” to indicate the presence of a Backoff Indicator field in the subheader (BI). The T field is set to “1” to indicate the presence of a RAPID field in the subheader.

The MAC subheader can include a Reserved (R) bit. The R bit can be set to zero. The MAC subheader can include a Backoff Indicator (BI) field which identifies the overload condition in the cell. The size of the BI field is 4 bits. The MAC subheader can include a RAPID field which identifies the transmitted random access reamble. In some implementations, the size of the RAPID field is 6 bits. In some implementations, if the RAPID in the MAC subheader of a MAC subPDU corresponds to one of the random access preambles configured for SI request, MAC RAR is not included in the MAC subPDU.

FIG. 8F illustrates an example of a MAC payload for a Random Access Response (“MAC RAR”). The Mac payload for a RAR can include the fields a illustrated by FIG. 8F. The MAC RAR can be fixed and can be octet aligned. The MAC RAR can include one or more of the following fields. The RAR can include a Reserved (R) bit. The R bit can be set to zero. The RAR can include a Timing Advance Command field indicates the index value TA used to control the amount of timing adjustment that the MAC entity has to apply, see, e.g., 3GPP TS 38.213. The size of the Timing Advance Command field is 12 bits. The RAR can include an Uplink Grant field which indicates the resources to be used on the uplink (see, e.g., 3GPP TS 38.213). In some implementations, the size of the UL Grant field is 27 bits. In some implementations, the RAR can include a Temporary C-RNTI field indicates the temporary identity that is used by the MAC entity during a random access procedure. The size of the Temporary C-RNTI field is 16 bits.

Instance(s) of RLC 830 may process requests from and provide indications to an instance of PDCP 840 via one or more radio link control service access points (RLC-SAP) 835. These requests and indications communicated via RLC-SAP 835 can include one or more RLC channels. The RLC 830 may operate in a plurality of modes of operation, including: Transparent Mode (TM), Unacknowledged Mode (UM), and Acknowledged Mode (AM). The RLC 830 may execute transfer of upper layer protocol data units (PDUs), error correction through automatic repeat request (ARQ) for AM data transfers, and concatenation, segmentation and reassembly of RLC SDUs for UM and AM data transfers. The RLC 830 may also execute re-segmentation of RLC data PDUs for AM data transfers, reorder RLC data PDUs for UM and AM data transfers, detect duplicate data for UM and AM data transfers, discard RLC SDUs for UM and AM data transfers, detect protocol errors for AM data transfers, and perform RLC re-establishment.

Instance(s) of PDCP 840 may process requests from and provide indications to instance(s) of RRC 855 and/or instance(s) of SDAP 847 via one or more packet data convergence protocol service access points (PDCP-SAP) 845. These requests and indications communicated via PDCP-SAP 845 can include one or more radio bearers. The PDCP 840 may execute header compression and decompression of IP data, maintain PDCP Sequence Numbers (SNs), perform in-sequence delivery of upper layer PDUs at re-establishment of lower layers, eliminate duplicates of lower layer SDUs at re-establishment of lower layers for radio bearers mapped on RLC AM, cipher and decipher control plane data, perform integrity protection and integrity verification of control plane data, control timer-based discard of data, and perform security operations (e.g., ciphering, deciphering, integrity protection, integrity verification, etc.).

Instance(s) of SDAP 847 may process requests from and provide indications to one or more higher layer protocol entities via one or more SDAP-SAP 849. These requests and indications communicated via SDAP-SAP 849 can include one or more QoS flows. The SDAP 847 may map QoS flows to DRBs, and vice versa, and may also mark QFIs in DL and UL packets. A single SDAP entity 847 may be configured for an individual PDU session. In the UL direction, the NG-RAN 110 may control the mapping of QoS Flows to DRB(s) in two different ways, reflective mapping or explicit mapping. For reflective mapping, the SDAP 847 of a UE 101 may monitor the QFIs of the DL packets for each DRB, and may apply the same mapping for packets flowing in the UL direction. For a DRB, the SDAP 847 of the UE 101 may map the UL packets belonging to the QoS flows(s) corresponding to the QoS flow ID(s) and PDU session observed in the DL packets for that DRB. To enable reflective mapping, the NG-RAN 110 may mark DL packets over the Uu interface with a QoS flow ID. The explicit mapping may involve the RRC 855 configuring the SDAP 847 with an explicit QoS flow to DRB mapping rule, which may be stored and followed by the SDAP 847. In some implementations, the SDAP 847 may be used in NR implementations and may not be used in LTE implementations.

The RRC 855 may configure, via one or more management service access points (M-SAP), aspects of one or more protocol layers, which may include one or more instances of PHY 810, MAC 820, RLC 830, PDCP 840 and SDAP 847. In some implementations, an instance of RRC 855 may process requests from and provide indications to one or more NAS entities 857 via one or more RRC-SAPs 856. The main services and functions of the RRC 855 may include broadcast of system information (e.g., included in MIBs or SIBs related to the NAS), broadcast of system information related to the access stratum (AS), paging, establishment, maintenance and release of an RRC connection between the UE 101 and RAN 110 (e.g., RRC connection paging, RRC connection establishment, RRC connection modification, and RRC connection release), establishment, configuration, maintenance and release of point to point Radio Bearers, security functions including key management, inter-RAT mobility, and measurement configuration for UE measurement reporting. The MIBs and SIBs can include one or more IEs, which may each comprise individual data fields or data structures. The NAS 857 may form the highest stratum of the control plane between the UE 101 and an AMF. The NAS 857 may support the mobility of the UEs 101 and the session management procedures to establish and maintain IP connectivity between the UE 101 and a P-GW in LTE systems.

In some implementations, one or more protocol entities of arrangement 800 may be implemented in UEs 101, RAN nodes 111, an AMF in NR implementations or MME in LTE implementations, UPF in NR implementations or S-GW and P-GW in LTE implementations, or the like to be used for control plane or user plane communications protocol stack between the aforementioned devices. In such embodiments, one or more protocol entities that may be implemented in one or more of UE 101, gNB 111, AMF, etc. may communicate with a respective peer protocol entity that may be implemented in or on another device using the services of respective lower layer protocol entities to perform such communication. In some implementations, a gNB-CU of the gNB 111 may host the RRC 855, SDAP 847, and PDCP 840 of the gNB that controls the operation of one or more gNB-DUs, and the gNB-DUs of the gNB 111 may each host the RLC 830, MAC 820, and PHY 810 of the gNB 111.

In some implementations, a control plane protocol stack can include, in order from highest layer to lowest layer, NAS 857, RRC 855, PDCP 840, RLC 830, MAC 820, and PHY 810. In this example, upper layers 860 may be built on top of the NAS 857, which includes an IP layer 861, an SCTP 862, and an application layer signaling protocol (AP) 863.

In some NR implementations, the AP 863 may be an NG application protocol layer (NGAP or NG-AP) 863 for the NG interface 113 defined between the NG-RAN node 111 and the AMF, or the AP 863 may be an Xn application protocol layer (XnAP or Xn-AP) 863 for the Xn interface 112 that is defined between two or more RAN nodes 111.

The NG-AP 863 may support the functions of the NG interface 113 and can include Elementary Procedures (EPs). An NG-AP EP may be a unit of interaction between the NG-RAN node 111 and the AMF. The NG-AP 863 services can include two groups: UE-associated services (e.g., services related to a UE 101) and non-UE-associated services (e.g., services related to the whole NG interface instance between the NG-RAN node 111 and AMF). These services may include functions including, but not limited to: a paging function for the sending of paging requests to NG-RAN nodes 111 involved in a particular paging area; a UE context management function for allowing the AMF to establish, modify, and/or release a UE context in the AMF and the NG-RAN node 111; a mobility function for UEs 101 in ECM-CONNECTED mode for intra-system HOs to support mobility within NG-RAN and inter-system HOs to support mobility from/to EPS systems; a NAS Signaling Transport function for transporting or rerouting NAS messages between UE 101 and AMF; a NAS node selection function for determining an association between the AMF and the UE 101; NG interface management function(s) for setting up the NG interface and monitoring for errors over the NG interface; a warning message transmission function for providing means to transfer warning messages via NG interface or cancel ongoing broadcast of warning messages; a Configuration Transfer function for requesting and transferring of RAN configuration information (e.g., SON information, performance measurement (PM) data, etc.) between two RAN nodes 111 via CN 120; and/or other like functions.

The XnAP 863 may support the functions of the Xn interface 112 and can include XnAP basic mobility procedures and XnAP global procedures. The XnAP basic mobility procedures can include procedures used to handle UE mobility within the NG RAN 110 (or E-UTRAN 110), such as handover preparation and cancellation procedures, SN Status Transfer procedures, UE context retrieval and UE context release procedures, RAN paging procedures, dual connectivity related procedures, and the like. The XnAP global procedures can include procedures that are not related to a specific UE 101, such as Xn interface setup and reset procedures, NG-RAN update procedures, cell activation procedures, and the like.

In LTE implementations, the AP 863 may be an S1 Application Protocol layer (S1-AP) 863 for the S1 interface 113 defined between an E-UTRAN node 111 and an MME, or the AP 863 may be an X2 application protocol layer (X2AP or X2-AP) 863 for the X2 interface 112 that is defined between two or more E-UTRAN nodes 111.

The S1 Application Protocol layer (S1-AP) 863 may support the functions of the S1 interface, and similar to the NG-AP discussed previously, the S1-AP can include S1-AP EPs. An S1-AP EP may be a unit of interaction between the E-UTRAN node 111 and an MME within an LTE CN 120. The S1-AP 863 services can include two groups: UE-associated services and non UE-associated services. These services perform functions including, but not limited to: E-UTRAN Radio Access Bearer (E-RAB) management, UE capability indication, mobility, NAS signaling transport, RAN Information Management (RIM), and configuration transfer.

The X2AP 863 may support the functions of the X2 interface 112 and can include X2AP basic mobility procedures and X2AP global procedures. The X2AP basic mobility procedures can include procedures used to handle UE mobility within the E-UTRAN 120, such as handover preparation and cancellation procedures, SN Status Transfer procedures, UE context retrieval and UE context release procedures, RAN paging procedures, dual connectivity related procedures, and the like. The X2AP global procedures can include procedures that are not related to a specific UE 101, such as X2 interface setup and reset procedures, load indication procedures, error indication procedures, cell activation procedures, and the like.

The SCTP layer (alternatively referred to as the SCTP/IP layer) 862 may provide guaranteed delivery of application layer messages (e.g., NGAP or XnAP messages in NR implementations, or S1-AP or X2AP messages in LTE implementations). The SCTP 862 may ensure reliable delivery of signaling messages between the RAN node 111 and the AMF/MME based, in part, on the IP protocol, supported by the IP 861. The Internet Protocol layer (IP) 861 may be used to perform packet addressing and routing functionality. In some implementations the IP layer 861 may use point-to-point transmission to deliver and convey PDUs. In this regard, the RAN node 111 can include L2 and L1 layer communication links (e.g., wired or wireless) with the MME/AMF to exchange information.

In a second example, a user plane protocol stack can include, in order from highest layer to lowest layer, SDAP 847, PDCP 840, RLC 830, MAC 820, and PHY 810. The user plane protocol stack may be used for communication between the UE 101, the RAN node 111, and UPF in NR implementations or an S-GW and P-GW in LTE implementations. In this example, upper layers 851 may be built on top of the SDAP 847, and may include a user datagram protocol (UDP) and IP security layer (UDP/IP) 852, a General Packet Radio Service (GPRS) Tunneling Protocol for the user plane layer (GTP-U) 853, and a User Plane PDU layer (UP PDU) 863.

The transport network layer 854 (also referred to as a “transport layer”) may be built on IP transport, and the GTP-U 853 may be used on top of the UDP/IP layer 852 (comprising a UDP layer and IP layer) to carry user plane PDUs (UP-PDUs). The IP layer (also referred to as the “Internet layer”) may be used to perform packet addressing and routing functionality. The IP layer may assign IP addresses to user data packets in any of IPv4, IPv6, or PPP formats, for example.

The GTP-U 853 may be used for carrying user data within the GPRS core network and between the radio access network and the core network. The user data transported can be packets in any of IPv4, IPv6, or PPP formats, for example. The UDP/IP 852 may provide checksums for data integrity, port numbers for addressing different functions at the source and destination, and encryption and authentication on the selected data flows. The RAN node 111 and the S-GW may utilize an S1-U interface to exchange user plane data via a protocol stack comprising an L1 layer (e.g., PHY 810), an L2 layer (e.g., MAC 820, RLC 830, PDCP 840, and/or SDAP 847), the UDP/IP layer 852, and the GTP-U 853. The S-GW and the P-GW may utilize an S5/S8a interface to exchange user plane data via a protocol stack comprising an L1 layer, an L2 layer, the UDP/IP layer 852, and the GTP-U 853. As discussed previously, NAS protocols may support the mobility of the UE 101 and the session management procedures to establish and maintain IP connectivity between the UE 101 and the P-GW.

Moreover, although not shown by FIG. 8A, an application layer may be present above the AP 863 and/or the transport network layer 854. The application layer may be a layer in which a user of the UE 101, RAN node 111, or other network element interacts with software applications being executed, for example, by application circuitry or application circuitry, respectively. The application layer may also provide one or more interfaces for software applications to interact with communications systems of the UE 101 or RAN node 111, such as baseband circuitry. In some implementations the IP layer and/or the application layer may provide the same or similar functionality as layers 5-7, or portions thereof, of the Open Systems Interconnection (OSI) model (e.g., OSI Layer 7—the application layer, OSI Layer 6—the presentation layer, and OSI Layer 5—the session layer).

To reduce access latency, the 4-step RACH procedure (e.g., FIG. 2) may be simplified to allow fast access and low latency uplink transmission. The 4-step RACH procedure can be consolidated into a 2-step RACH procedure (e.g., FIG. 3), where a UE combines Msg1 and Msg3 in the 4-step RACH procedure for a low latency PRACH transmission. Further, the 2-step RACH procedure may also be beneficial on the support of mMTC, where MTC devices may simply wake up, transmit uplink data, and go back to sleep using a 2-step RACH procedure.

The 2-step RACH procedure can be used for initial access and handover. In some implementations, the 2-step RACH procedure can be triggered by a UE in RRC idle mode or in RRC connected mode. If the 2-step RACH procedure is used for initial access, the parameters for the 2-step RACH procedure including resources for MsgA can be broadcasted.

In cases where Msg2 and Msg4 are multiplexed in a single MsgB transmission, which is carried by a PDSCH, and given that MsgB transmission can be targeted for multiple UEs (e.g., for UEs in RRC_IDLE or RRC_INACTIVE mode), the UE can provide feedback to the gNB to indicate whether the MsgB is successfully received. In cases where the UE does not receive the MsgB successfully, the gNB can schedule the retransmission of the MsgB for the UE. To enable these features, certain mechanisms for MsgB response may need to be defined for the 2-step RACH procedure. The present disclosure provides techniques for providing such MsgB responses for the 2-step RACH procedure. Techniques for mapping(s) between PRACH preamble(s) and PUSCH resource unit(s) for the 2-step RACH procedure are also disclosed.

The network can configure uplink resources for the UE to use or cause the UE to use a predefined resource for transmitting feedback in response to receiving a MsgB. In some NR implementations, a PUCCH resource set, which can include 256 PUCCH resources, can be defined for initial access to a wireless network. In some implementations, a 4-bit field in NR Remaining Minimum System Information (RMSI) is used to indicate one of 16 cell specific PUCCH resources. This 4-bit field is a pucch-ResourceCommon in the PUCCH-ConfigCommon IE, which can be used to configure cell specific PUCCH parameters. Table 8 provides an excerpted example of a PUCCH-ConfigCommon information element. The information element can include a hoppingId field which is a cell-specific scrambling ID for group hopping and sequence hopping if enabled (see, e.g., 3GPP TS 38.211, clause 6.3.2.2). The information element can include a p0-nominal field which provides a power control parameter PO for PUCCH transmissions, its value can be in dBm (see, e.g., 3GPP TS 38.213, clause 7.2). The information element can include a pucch-GroupHopping field: configuration of group- and sequence hopping for all the PUCCH formats 0, 1, 3, and 4. The field's enable value can enable group hopping and disables sequence hopping, whereas a disable value can disable group hopping and enables sequence hopping (see, e.g., 3GPP TS 38.211, clause 6.3.2.2). The element can include a pucch-ResourceCommon field, which represents an entry into a 16-row table where each row configures a set of cell-specific PUCCH resources/parameters. The UE uses those PUCCH resources during initial access on the initial uplink BWP. Once the network provides a dedicated PUCCH-Config for that bandwidth part the UE applies that one instead of the one provided in this field (see 3GPP TS 38.213, clause 9.2).

TABLE 8

| | |
|---|---|
| PUCCH-ConfigCommon ::= | SEQUENCE { |
| pucch-ResourceCommon | INTEGER (0..15), |
| pucch-GroupHopping | ENUMERATED { neither, enable, |
| | disable }, |
| hoppingId | INTEGER (0..1023), |
| p0-nominal | INTEGER (−202..24), |

...
}

For initial access (e.g., HARQ-ACK feedback for the corresponding Msg4 transmission in the 4-step RACH procedure) or for UE which is not provided with dedicated PUCCH resource configuration, a PUCCH resource indicator (PRI) in DCI and starting control channel element (CCE) of a corresponding PDCCH can be used to determine a PUCCH resource from the 16 resources for carrying 1-bit HARQ-ACK feedback.

If a UE does not have a dedicated PUCCH resource configuration, which can be provided by PUCCH-ResourceSet in PUCCH-Config, a PUCCH resource set is provided by pucch-ResourceCommon through an index to a row of Table 9 (which provides PUCCH resource sets before a dedicated PUCCH resource configuration) for transmission of HARQ-ACK information on PUCCH in an initial UL BWP of N_{BWP}^{size} PRBs. The PUCCH resource set includes sixteen resources, each corresponding to a PUCCH format, a first symbol, a duration, a PRB offset RB_{BWP}^{offset}, and a cyclic shift index set for a PUCCH transmission. The UE transmits a PUCCH using frequency hopping. An orthogonal cover code with index 0 is used for a PUCCH resource with PUCCH format 1 in Table 9. In some implementations, the UE transmits the PUCCH using the same spatial domain transmission filter as for a PUSCH transmission scheduled by a RAR UL grant (see, e.g., 3GPP TS 38.213, clause 8.3). In some implementations, the UE does not expect to generate more than one HARQ-ACK information bit prior to establishing RRC connection as described in 3GPP TS 38.331.

TABLE 9
PUCCH resource sets before dedicated
PUCCH resource configuration

| | PUCCH | First | Number of | PRB offset | Set of initial |
|---|---|---|---|---|---|
| Index | format | symbol | symbols | RB_{BWP}^{offset} | CS indexes |
| 0 | 0 | 12 | 2 | 0 | {0, 3} |
| 1 | 0 | 12 | 2 | 0 | {0, 4, 8} |
| 2 | 0 | 12 | 2 | 3 | {0, 4, 8} |
| 3 | 1 | 10 | 4 | 0 | {0, 6} |
| 4 | 1 | 10 | 4 | 0 | {0, 3, 6, 9} |
| 5 | 1 | 10 | 4 | 2 | {0, 3, 6, 9} |
| 6 | 1 | 10 | 4 | 4 | {0, 3, 6, 9} |
| 7 | 1 | 4 | 10 | 0 | {0, 6} |
| 8 | 1 | 4 | 10 | 0 | {0, 3, 6, 9} |
| 9 | 1 | 4 | 10 | 2 | {0, 3, 6, 9} |
| 10 | 1 | 4 | 10 | 4 | {0, 3, 6, 9} |
| 11 | 1 | 0 | 14 | 0 | {0, 6} |
| 12 | 1 | 0 | 14 | 0 | {0, 3, 6, 9} |
| 13 | 1 | 0 | 14 | 2 | {0, 3, 6, 9} |
| 14 | 1 | 0 | 14 | 4 | {0, 3, 6, 9} |
| 15 | 1 | 0 | 14 | └N_{BWP}^{size}/4┘ | {0, 3, 6, 9} |

In some implementations, if the UE provides HARQ-ACK information in a PUCCH transmission in response to detecting a message based on a DCI format 1_0 or DCI format 1_1, the UE determines a PUCCH resource with index r_{PUCCH} 0≤r_{PUCCH}≤15, as

$${r}_{PUCCH} = ⌊ \frac{2 \cdot {n}_{CCE , 0}}{{N}_{CCE}} ⌋ + 2 \cdot {Δ}_{P R I} ,$$

where N_{CCE} is a number of CCEs in a CORESET of a PDCCH reception with DCI format 1_0 or DCI format 1_1, n_{CCE,0} is the index of a first CCE for the PDCCH reception, and Δ_{PRI} is a value of the PUCCH resource indicator field in the DCI format 1_0 or DCI format 1_1. If └r_{PUCCH}/8┘0, then the UE determines the PRB index of the PUCCH transmission in the first hop as RB_{BWP}^{offset}+└r_{PUCCH}/N_{CS}┘ and the PRB index of the PUCCH transmission in the second hop as N_{BWP}^{size}−1−RB_{BWP}^{offset}−└r_{PUCCH}/N_{CS}┘ where N_{CS} is the total number of initial cyclic shift indexes in the set of initial cyclic shift indexes; and/or the UE determines the initial cyclic shift index in the set of initial cyclic shift indexes as r_{PUCCH} mod N_{CS}. If └r_{PUCCH}/8┘=1, then the UE determines the PRB index of the PUCCH transmission in the first hop as N_{BWP}^{size}−1−RB_{BWP}^{offset}−└(r_{PUCCH}−8)/N_{CS}┘ and the PRB index of the PUCCH transmission in the second hop as RB_{BWP}^{offset}+└(r_{PUCCH}−8)N_{CS}┘; and/or the UE determines the initial cyclic shift index in the set of initial cyclic shift indexes as (r_{PUCCH}−8)mod N_{CS}.

If a UE has a dedicated PUCCH resource configuration, the UE is provided by higher layers with one or more PUCCH resources. In some implementations, a PUCCH resource includes the following parameters: a PRI provided by pucch-ResourceId; an index of the first PRB prior to frequency hopping or for no frequency hopping by startingPRB; an index of the first PRB after frequency hopping by secondHopPRB; an indication for intra-slot frequency hopping by intraSlotFrequencyHopping; and a configuration for a PUCCH format, from PUCCH format 0 through PUCCH format 4, provided by a format parameter.

If the format parameter indicates PUCCH-format0, the PUCCH format configured for a PUCCH resource is PUCCH format 0, where the PUCCH resource also includes an index for an initial cyclic shift provided by initialCyclicShift, a number of symbols for a PUCCH transmission provided by nrofSymbols, a first symbol for the PUCCH transmission provided by startingSymbolIndex. If the format indicates PUCCH-format1, the PUCCH format configured for a PUCCH resource is PUCCH format 1, where the PUCCH resource also includes an index for an initial cyclic shift provided by initialCyclicShift, a number of symbols for a PUCCH transmission provided by nrofSymbols, a first symbol for the PUCCH transmission provided by startingSymbolIndex, and an index for an orthogonal cover code by timeDomainOCC. If the format indicates PUCCH-format2 or PUCCH-format3, the PUCCH format configured for a PUCCH resource is PUCCH format 2 or PUCCH format 3, respectively, where the PUCCH resource also includes a number of PRBs provided by nrofPRBs, a number of symbols for a PUCCH transmission provided by nrofSymbols, and a first symbol for the PUCCH transmission provided by startingSymbolIndex. If the format indicates PUCCH-format4, the PUCCH format configured for a PUCCH resource is PUCCH format 4, where the PUCCH resource also includes a number of symbols for a PUCCH transmission provided by nrofSymbols, a length for an orthogonal cover code by occ-Length, an index for an orthogonal cover code by occ-Index, and a first symbol for the PUCCH transmission provided by startingSymbolIndex.

In some implementations, a UE can be configured to have up to four sets of PUCCH resources. A PUCCH resource set can be provided by PUCCH-ResourceSet and is associated with a PUCCH resource set index provided by pucch-ResourceSetId, with a set of PUCCH resource indexes provided by resourceList that provides a set of pucch-ResourceId used in the PUCCH resource set, and with a maximum number of UCI information bits the UE can transmit using a PUCCH resource in the PUCCH resource set provided by maxPayloadMinus1. In some implementations, for one or more PUCCH resource sets, the maximum number of UCI information bits is 2. A maximum number of PUCCH resource indexes for a set of PUCCH resources can be provided by maxNrofPUCCH-ResourcesPerSet. In some implementations, the maximum number of PUCCH resources in a PUCCH resource set is 32 and the maximum number of PUCCH resources in other PUCCH resource sets is 8.

In some implementations, if the UE transmits O_{UCI} UCI information bits, that include HARQ-ACK information bits, the UE determines a PUCCH resource set to be: (1) a first set of PUCCH resources with pucch-ResourceSetId=0 if O_{UCI}≤2 including 1 or 2 HARQ-ACK information bits and a positive or negative SR on one SR transmission occasion if transmission of HARQ-ACK information and SR occur simultaneously; (2) a second set of PUCCH resources with pucch-ResourceSetId=1, if provided by higher layers, if 2<O_{UCI}≤N₂ where N₂ is equal to maxPayloadMinus1 if maxPayloadMinus1 is provided for the PUCCH resource set with pucch-ResourceSetId=1; otherwise N₂ is equal to 1706; (3) a third set of PUCCH resources with pucch-ResourceSead=2, if provided by higher layers, if N₂<O_{UCI}≤N₃ where N₃ is equal to maxPayloadMinus1 if maxPayloadMinus1 is provided for the PUCCH resource set with pucch-ResourceSead=2; otherwise N₃ is equal to 1706; or (4) a fourth set of PUCCH resources with pucch-ResourceSead=3, if provided by higher layers and if N₃<O_{UCI}≤1706.

A MsgB transmission can be targeted for multiple UEs (e.g., for UEs in RRC_IDLE or RRC_INACTIVE mode). As such, the UE may need to provide feedback to the gNB to indicate whether the MsgB was successfully received. When the UE does not receive the MsgB correctly, the gNB may schedule the retransmission of the MsgB for the UE.

In some implementations, a UL grant is included in a MAC CE of a MsgB for a 2-step RACH procedure. This may be applicable for Contention Based Random Access (CBRA), Contention Free Random Access (CFRA), or both. Further, this may be applicable for a UE in RRC_IDLE, RRC_INACTIVE, or RRC_CONNECTED modes. This may be also applicable for some or all triggers for a 2-step RACH procedure. In some implementations, a PUSCH transmission in accordance with the UL grant may indicate that the UE successfully received the MsgB from the gNB. For some triggers, when the UE does not have data in the buffer (e.g., the UE's MAC entity UL buffer, one or more HARQ process buffers, and/or a Msg3 buffer), the UE may send dummy data on PUSCH.

In some implementations, the MAC entity does not generate a MAC PDU for the HARQ entity if the following conditions are satisfied: the MAC entity is configured with skip UplinkTxDynamic with value true and the grant indicated to the HARQ entity was addressed to a C-RNTI and is not included in MsgB of the 2-step RACH procedure, or the grant indicated to the HARQ entity is a configured uplink grant; there is no aperiodic CSI requested for this PUSCH transmission as specified in 3GPP TS 38.212; the MAC PDU includes zero MAC SDUs; and the MAC PDU includes only the periodic BSR and there is no data available for any LCG, or the MAC PDU includes only the padding BSR (see e.g., clause 5.4.3.1.3 in 3GPP TS 38.321). The MAC entity can generate a MAC PDU for the HARQ entity if the grant indicated to the HARQ entity is included in MsgB of 2-step RACH.

In some implementations, for UEs in RRC_CONNECTED mode, MsgB transmission may be scheduled by a PDCCH with CRC scrambled by a C-RNTI. In some implementations, the UE may can provide HARQ-ACK feedback of the corresponding MsgB transmission on a PUCCH resource based on 3GPP TS 38.213, clause 9.2.3. In some implementations, when the UE is provided with dedicated PUCCH resources, the UE can determine a PUCCH resource from the configured PUCCH resource sets based on the PRI and starting CCE to transmit HARQ-ACK feedback. When the UE is not provided by dedicated PUCCH resources, the UE can determine a PUCCH resource from the PUCCH resource set based on the PRI and starting CCE to transmit HARQ-ACK feedback. In some implementations, a resource set can be configured by pucch-ResourceCommon.

When a UL grant is included in the MsgB and PRI is included in the DCI for scheduling of MsgB transmission, the UE may transmit both PUSCH and HARQ-ACK feedback of a corresponding MsgB on the determined PUCCH resource. When the PUCCH and PUSCH overlap in time in a slot within a PUCCH group, the UE may multiplex the HARQ-ACK on the PUSCH and drop the PUCCH transmission.

In some implementations, the UE may transmit one of the PUSCH or the PUCCH carrying the HARQ-ACK feedback. For example, the UE may transmit the PUSCH and drop the PUCCH transmission, or vice versa. In the former case, this may indicate that the UE would ignore the PRI field in the DCI scheduling MsgB transmission.

In some implementations, for UEs in RRC_IDLE and RRC_INACTIVE mode, a MsgB transmission may be scheduled by a PDCCH with a CRC scrambled by a RA-RNTI or a RNTI associated with the MsgB, which can be referred to as MsgB-RNTI. This RA-RNTI or MsgB-RNTI may be the same or different from the existing RA-RNTI as defined for the Rel-15 4-step RACH procedure, which is used on the PDCCH when RAR messages are transmitted, and unambiguously identifies which time-frequency resource was utilized by the MAC entity to transmit the random access preamble.

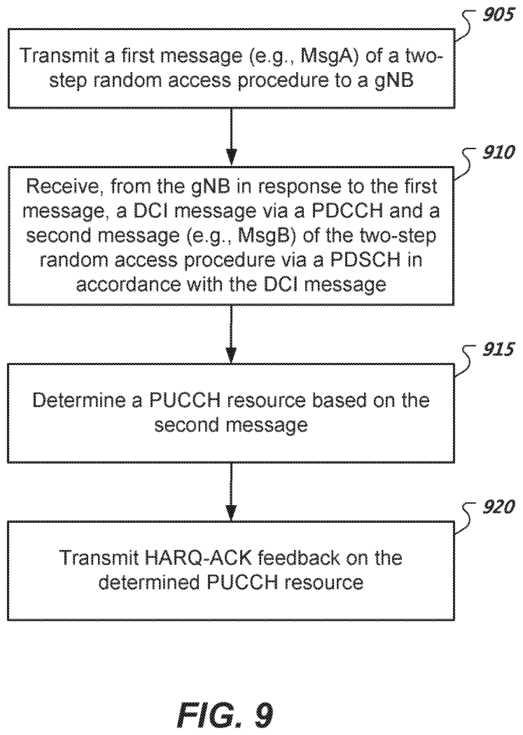

FIG. 9 illustrates an example of a two-step random access procedure that additionally includes a feedback transmission. At 905, the UE transmits a first message (e.g., MsgA) of a two-step random access procedure to a gNB. In some implementations, the first message includes a MsgA as illustrated by FIG. 3.

At 910, the UE receives, from the gNB in response to the first message, a DCI message via a PDCCH and a second message of the two-step random access procedure via a PDSCH in accordance with the DCI message. In some implementations, the second message includes a MsgB as illustrated by FIG. 3. The DCI message can schedule the second message, and the UE can use the DCI message to receive the second message on one or more scheduled resources. A CRC associated with the DCI message can be scrambled by a RNTI such as a C-RNTI or a MsgB-RNTI. In some implementations, the second message is included in a MAC CE or MAC PDU carried by the PDSCH. In some implementations, the second message includes an uplink grant field that indicates one or more resources for the uplink. In some implementations, the determined PUCCH resource is based on the uplink grant field.

At 915, the UE determines a PUCCH resource based on the second message. In some implementations, the UE can receive information that provides a configuration of a PUCCH resource set. The second message can include a PUCCH resource indicator field that identifies a resource within the PUCCH resource set, and the determined PUCCH resource can be based on the PUCCH resource indicator field.

At 920, the UE transmits HARQ-ACK feedback for the second message on the determined PUCCH resource. In some implementations, the second message includes a RAR message, the RAR message includes a PDSCH-to-HARQ feedback timing indicator field, and transmitting the HARQ-ACK feedback can include using a slot that is based on the PDSCH-to-HARQ feedback timing indicator field. The HARQ-ACK feedback can include an ACK if the UE correctly detects the transport block associated with the MsgB. The HARQ-ACK feedback can include a NACK if the UE incorrectly detects the transport block associated with the MsgB.

In some implementations, transmitting the HARQ-ACK feedback includes using a spatial domain transmission filter that was used in a last PUSCH transmission from the UE, e.g., a PUSCH transmission associated with MsgA. In some implementations, the UE is configured to use the same DM-RS antenna port quasi co-location properties as for a SS/PBCH block the UE used for a PRACH association.

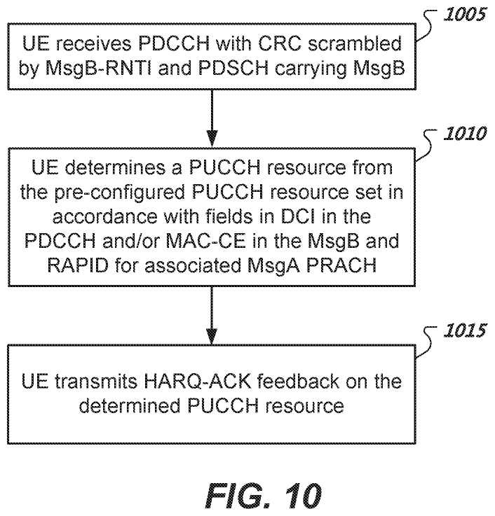

FIG. 10 illustrates an example of a procedure to determine PUCCH resource for HARQ-ACK feedback of a corresponding MsgB transmission. At 1005, the UE receives PDCCH with CRC scrambled by MsgB-RNTI and PDSCH carrying MsgB. At 1010, the UE determines a PUCCH resource from the configured PUCCH resource set in accordance with fields in DCI in the PDCCH and/or MAC CE in the MsgB and RAPID for an associated MsgA PRACH. At 1015, the UE transmits HARQ-ACK feedback on the determined PUCCH resource. After 1015, the procedure may end or repeat as necessary.

The PUCCH resource set for the 2-step RACH procedure may be configured using a parameter such as a 4-bit pucch-ResourceCommon field in RMSI. In some implementations, the PUCCH resource set includes 16 cell specific PUCCH resources. In some implementations, to determine a PUCCH resource from the configured PUCCH resource set and transmission timing of the PUCCH, a PDSCH-to-HARQ-timing-indicator and/or PUCCH resource index r_{PUCCH} may be included in the DCI scheduling the MsgB transmission or a MAC CE or RAR in the MsgB.

In some implementations, a K bit PDSCH-to-HARQ-timing-indicator can be included in the DCI for scheduling MsgB transmissions, which may reuse the reserved bits in the DCI format with CRC scrambled by MsgB-RNTI or RA-RNTI, where K can be predefined (e.g., K=3) or configured by NR RMSI, NR other system information (OSI), or RRC signaling. In some implementations, PDSCH-to-HARQ-timing-indicator values can be an integer between 1 and 8.

A gNB can use DCI format 1_0 for the scheduling of PDSCH in one DL cell, where the following information is transmitted by means of DCI format 1_0 with CRC scrambled by MsgB-RNTI: frequency domain resource assignment−┌log₂(N_{RB}^{DL,BWP}(N_{RB}^{DL,BWP}+1)/2)┐ bits, where N_{RB}^{DL,BWP} is the size of CORESET 0 if CORESET 0 is configured for the cell and N_{RB}^{DL,BWP} is the size of initial DL bandwidth part if CORESET 0 is not configured for the cell; time domain resource assignment—4 bits as defined in clause 5.1.2.1 of 3GPP TS 38.214; VRB-to-PRB mapping—1 bit according to Table 7.3.1.1.2-33; modulation and coding scheme—5 bits as defined in clause 5.1.3 of 3GPP TS 38.214, using Table 5.1.3.1-1; TB scaling—2 bits as defined in clause 5.1.3.2 of 3GPP TS 38.214; PDSCH-to-HARQ_feedback timing indicator—3 bits as defined in clause 9.2.3 of 3GPP TS 38.213; and reserved bits—13 bits. Other parameters as discussed in 3GPP TS 38.212 may also be included in the DCI format 1_0. In some implementations, the PDSCH-to-HARQ_feedback timing indicator may be included in a MAC CE or RAR in MsgB for the associated RAPID of a corresponding MsgA PRACH transmission.

In some implementations, a PUCCH resource index r_{PUCCH} can be included in a MAC CE or RAR in the MsgB for the associated RAPID of a corresponding MsgA PRACH transmission. In some implementations, r_{PUCCH} is a 4-bit parameter, which is used to select one PUCCH resource from 16 PUCCH resources within a configured PUCCH resource set. In some implementations, the PRI (3-bit) may be included in the MAC CE or RAR in MsgB for the associated RAPID of corresponding MsgA PRACH transmission. The UE can determine a PUCCH resource based on the indicated PRI in MsgB and starting CCE index of PDCCH scheduling MsgB transmission by deriving the PUCCH resource index r_{PUCCH}. In some implementations, the formula to derive the PUCCH resource index r_{PUCCH} can be based on 3GPP TS 38.213, clause 9.2.1.

In some implementations, a timer may be defined at the network side to decide whether the UE has sent the HARQ feedback. If the timer expires, the network considers that the MsgB reception at the UE has failed, e.g., HARQ NACK. Otherwise, if a HARQ ACK has been received by the network, the network stops the timer and considers the 2-step RACH procedure to have completed successfully.

In some implementations, spatial filter or Tx beam for the (re)transmission of PUSCH, which is scheduled by UL grant in MsgB, can be same as that of MsgA PRACH or MsgA PUSCH transmission. For instance, if different spatial filters are applied for the transmission of MsgA PRACH and PUSCH, UE may apply the same spatial filter for MsgA PUSCH and PUSCH transmission which is scheduled by a UL grant in MsgB. In some implementations, the spatial filter or Tx beam for the transmission of PUCCH carrying HARQ-ACK feedback of corresponding MsgB, can be the same as that of a MsgA PRACH or MsgA PUSCH transmission. In some implementations, the spatial filter or Tx beam for the transmission of PUCCH carrying HARQ-ACK feedback of corresponding MsgB could be configured by higher layer signaling (e.g., spatial relation information indicated by MAC CE or RRC signaling). If the spatial relation information is not configured, such spatial filter or Tx beam can be the same as that of corresponding MsgA PRACH or MsgA PUSCH transmission.

In some implementations, when detecting a DCI format in response to a PUSCH transmission scheduled by a MsgB UL grant, or corresponding PUSCH retransmission scheduled by a DCI format 0_0 with CRC scrambled by a TC-RNTI, provided in the corresponding MsgB message, the UE may assume the PDCCH carrying the DCI format has the same DM-RS antenna port quasi co-location properties, as for a SS/PBCH block the UE used for MsgA PRACH or MsgA PUSCH association, regardless of whether or not the UE is provided TCI-State for the CORESET where the UE receives the PDCCH with the DCI format.

In some implementations, when the UE decodes the PDCCH addressed to the C-RNTI sent in MsgA during the MsgB reception timer window and the DCI contains a DL allocation but the UE is unable to decode the corresponding allocated PDSCH (containing, for example, a timing advance command (TAC)), the UE responds with a NACK on the PUCCH indicated by the DCI and restarts the MsgB reception timer. The UE continues to monitor for PDCCH addressed to the C-RNTI sent in MsgA for the resource allocation of the PDSCH. For every subsequent failure to decode the PDSCH, the UE responds with NACK and restarts the MsgB reception timer. In addition, the UE can also monitor for PDCCH addressed to the RA-RNTI or MsgB-RNTI for fallback to a 4-step RACH during the subsequent MsgB reception duration. If the UE does not receive the PDCCH addressed to C-RNTI or RA-RNTI or MsgB-RNTI upon expiry of a MsgB reception timer, the UE can re-attempt the 2-step RACH procedure. In some implementations, instead of restarting the MsgB reception timer window, the UE continues monitoring for PDCCH addressed to the C-RNTI sent in MsgA in the existing MsgB reception timer window. This means that the MsgB reception timer has to take into consideration also retransmission of MsgB. Upon expiry of the timer, the UE can re-attempt the 2-step RACH procedure. When the UE decodes the PDCCH addressed to the C-RNTI sent in MsgA during the MsgB reception window and the DCI contains a UL grant (e.g., the UE has valid TA), the UE considers contention resolution successful and random access procedure is successfully completed.

In some implementations, when the UE decodes the PDCCH addressed to the RA-RNTI or MsgB-RNTI and the UE is unable to decode the allocated PDSCH during the MsgB reception timer window, the UE considers there to be no reception of a MsgB and continues monitoring for a PDCCH addressed to the RA-RNTI or MsgB-RNTI until the end of the MsgB reception timer window. Upon expiry of the MsgB reception timer window, the UE re-attempts the 2-step RACH procedure.

When the UE decodes the PDCCH addressed to the RA-RNTI or MsgB-RNTI and the UE is able to decode the allocated PDSCH, and if the PDSCH contains a UL grant for the HARQ feedback, the UE stops the MsgB reception timer and sends PUSCH with or without HARQ-ACK on PUSCH and considers contention resolution successful and random access procedure is successfully completed. When the UE decodes the PDCCH addressed to the RA-RNTI or MsgB-RNTI and the UE is able to decode the allocated PDSCH, and if the PDSCH contains PUCCH allocation index for the HARQ feedback, UE stops the MsgB reception timer and sends the ACK on the PUCCH resource indicated and considers contention resolution successful and random access procedure is successfully completed.

A random access procedure can include transmitting, by a UE, a MsgA, receiving, by a UE, a PDCCH with a CRC scrambled by a MsgB Radio Network Temporary Identifier (MsgB-RNTI) and receiving a PDSCH carrying a MsgB; determining, by the UE, a PUCCH resource from the configured PUCCH resource set in accordance with fields in DCI in the PDCCH, a MAC CE, and/or RAR in the MsgB and RAPID for the associated MsgA PRACH; and transmitting, by the UE, HARQ-ACK feedback of the corresponding MsgB on the determined PUCCH resource.

In some implementations, a UL grant is included in the MAC CE in the MsgB for a 2-step RACH procedure. In some implementations, when UE does not have data in the buffer, UE may send dummy data on PUSCH. In some implementations, for UEs in RRC_CONNECTED mode, UE may follow Rel-15 UE behavior to provide the HARQ-ACK feedback of the corresponding MsgB transmission on a PUCCH resource. In some implementations, when UL grant is included in the MsgB and PRI is included in the DCI for scheduling of MsgB transmission, UE may transmit both PUSCH and HARQ-ACK feedback of corresponding MsgB on the determined PUCCH resource. In some implementations, UE may only transmit one of PUSCH or PUCCH carrying HARQ-ACK feedback. In some implementations, the PUCCH resource set for 2-step RACH may be configured using the same parameter, e.g., 4-bit pucch-Resource Common field in RMSI or based on a new parameter, which is separately configured.

In some implementations, to determine a PUCCH resource from the configured PUCCH resource set and transmission timing of the PUCCH, PDSCH-to-HARQ-timing-indicator and/or PUCCH resource index r_{PUCCH} may be included in the DCI scheduling MsgB transmission or MAC CE/RAR in the MsgB. In some implementations, K bit PDSCH-to-HARQ-timing-indicator may be included in the DCI for scheduling MsgB transmission, which may reuse the reserved bits in DCI format with CRC scrambled by MsgB-RNTI or RA-RNTI, where K may be predefined. In some implementations, PDSCH-to-HARQ_feedback timing indicator may be included in the MAC CE or RAR in MsgB for the associated RAPID of corresponding MsgA PRACH transmission. In some implementations, PUCCH resource index r_{PUCCH} may be directly included in the MAC CE or RAR in MsgB for the associated RAPID of corresponding MsgA PRACH transmission. In some implementations, PRI (3-bit) may be included in the MAC CE or RAR in MsgB for the associated RAPID of corresponding MsgA PRACH transmission, wherein UE determines the PUCCH resource based on the indicated PRI in MsgB and starting CCE index of PDCCH scheduling MsgB transmission by deriving the PUCCH resource index r_{PUCCH}. In some implementations, a timer may be defined at the network side to decide whether the UE has sent the HARQ feedback.

In some implementations, a spatial filter or Tx beam for the transmission of PUSCH, which is scheduled by UL grant in MsgB, can be the same as that of MsgA PRACH or MsgA PUSCH transmission. In some implementations, a spatial filter or Tx beam for the transmission of PUCCH carrying HARQ-ACK feedback of corresponding MsgB, can be same as that of MsgA PRACH or MsgA PUSCH transmission. In some implementations, when detecting a DCI format in response to a PUSCH transmission scheduled by a MsgB UL grant, or corresponding PUSCH retransmission scheduled by a DCI format 0_0 with CRC scrambled by a TC-RNTI, provided in the corresponding MsgB message, the UE may assume the PDCCH carrying the DCI format has the same DM-RS antenna port quasi co-location properties, as for a SS/PBCH block the UE used for MsgA PRACH or MsgA PUSCH association, regardless of whether or not the UE is provided TCI-State for the CORESET where the UE receives the PDCCH with the DCI format.

In some implementations, in the case where UE decodes the PDCCH addressed to the C-RNTI sent in MsgA during the MsgB reception timer window and the DCI contains a DL allocation but the UE is unable to decode the corresponding allocated PDSCH (containing, e.g., TAC), the UE responds with a NACK on the PUCCH resource indicated by the DCI and restarts the MsgB reception timer. In some implementations, instead of restarting the MsgB reception timer window, the UE continues monitoring for PDCCH addressed to the C-RNTI sent in MsgA in the existing MsgB reception timer window. In some implementations, in the case where UE decodes the PDCCH addressed to the RA-RNTI or MsgB-RNTI and the UE is unable to decode the allocated PDSCH during the MsgB reception timer window, the UE considers no reception of MsgB and continues monitoring for PDCCH addressed to the RA-RNTI or MsgB-RNTI until the end of the MsgB reception timer window.

Another random access technique can include generating feedback for a MsgB received during a 2-step RACH procedure; and transmitting the feedback. The feedback can indicate a successful or unsuccessful receipt and decoding of the MsgB. The technique can include receiving a PDCCH transmission with a CRC scrambled by a C-RNTI, the PDCCH transmission scheduling the MsgB transmission; and receiving a PDSCH transmission carrying the MsgB. In some implementations, the feedback is HARQ feedback, and the transmitting includes transmitting the HARQ feedback on a PUCCH resource.

In some implementations, a UL grant is included in a MAC CE in the MsgB for the 2-step RACH procedure. In some implementations, a PUSCH transmission in accordance with the UL grant indicates the successful receipt and decoding of the MsgB. In some implementations, the transmitting comprises transmitting dummy data on a PUSCH when there is no data in a UL buffer.

The technique can include operating a MAC entity to not generate a MAC PDU for a HARQ entity if the MAC entity is configured with skipUplinkTxDynamic with a value of true and a grant indicated to the HARQ entity was addressed to a C-RNTI and is not included in MsgB of the 2-step RACH procedure, or the grant indicated to the HARQ entity is the configured UL grant. The technique can include operating a MAC entity to generate a MAC PDU for the HARQ entity if the grant indicated to the HARQ entity is included in MsgB of 2-step RACH procedure.

The technique can include, when one or more dedicated PUCCH resources are provided or configured, determining a PUCCH resource on which to transmit the HARQ feedback from one or more configured PUCCH resource sets based on a PRI and a starting CCE. The technique can include, when one or more dedicated PUCCH resources are not provided or configured, determining a PUCCH resource on which to transmit the HARQ feedback based on a PRI and starting CCE. In some implementations, the PRI and/or the starting CCE are indicated by received DCI. In some implementations, when a UL grant is included in the MsgB and the PRI is included in the DCI for scheduling of the MsgB transmission, the transmitting comprise transmitting both a PUSCH transmission and the HARQ feedback on the determined PUCCH resource. In some implementations, when the PUCCH and the PUSCH overlap in time in a slot within a PUCCH group, the technique includes multiplexing the HARQ feedback on the PUSCH; and dropping the PUCCH transmission. In some implementations, the transmitting comprises transmitting only one of a PUSCH transmission or a PUCCH transmission carrying the HARQ feedback on the determined PUCCH resource.

The technique can include receiving a PDCCH transmission with a CRC scrambled by a RA-RNTI or a MsgB-RNTI, the PDCCH transmission scheduling the MsgB transmission; and receiving a PDSCH transmission carrying the MsgB. The technique can include determining a PUCCH resource from one or more preconfigured PUCCH resource sets in accordance with fields in a DCI carried by the PDCCH, a MAC CE or a RAR in the MsgB, and/or a RAPID for an associated MsgA PRACH. In some implementations, the feedback is HARQ feedback, and the transmitting includes transmitting the HARQ feedback on the determined PUCCH resource.

Determining the PUCCH resource from the one or more preconfigured PUCCH resource sets can include determining the PUCCH resource based on a value of a PDSCH-to-HARQ-timing-indicator field in the DCI. In some implementations, determining the PUCCH resource from the one or more preconfigured PUCCH resource sets includes determining the PUCCH resource based on a value of a PDSCH-to-HARQ-timing-indicator field in the MAC CE or the RAR in the MsgB. In some implementations, determining the PUCCH resource from the one or more preconfigured PUCCH resource sets comprises determining the PUCCH resource based on a value of a PUCCH resource index r_{PUCCH} included in the DCI. In some implementations, determining the PUCCH resource from the one or more preconfigured PUCCH resource sets comprises determining the PUCCH resource based on a value of a PUCCH resource index r_{PUCCH} included in the MAC CE or the RAR in the MsgB. The technique can include determining a transmission timing of the PUCCH based on the value of the PDSCH-to-HARQ-timing-indicator field in the DCI. The technique can include determining a transmission timing of the PUCCH based on the value of the PDSCH-to-HARQ-timing-indicator field in the MAC CE or the RAR in the MsgB. The technique can include determining a transmission timing of the PUCCH based on the value of the PUCCH resource index r_{PUCCH} included in the DCI. The technique can include determining a transmission timing of the PUCCH based on the value of the PUCCH resource index r_{PUCCH} included in the MAC CE or the RAR in the MsgB.

In some implementations, the PDSCH-to-HARQ-timing-indicator includes K bits, wherein a value of K is predefined, or configured via NR RMSI, OSI, or RRC signaling. In some implementations, value of K is predefined, K=3. In some implementations, the value of K maps to a value from a set of {1, 2, 3, 4, 5, 6, 7, 8}. In some implementations, the DCI message is DCI format 1_0. In some implementations, the PUCCH resource index r_{PUCCH} is directly included in the MAC CE or RAR in MsgB for an associated RAPID of a corresponding MsgA PRACH transmission, wherein the PUCCH resource index r_{PUCCH} is a 4-bit parameter, which is used for selection of one PUCCH resource from 16 PUCCH resources within the preconfigured PUCCH resource set. In some implementations, the one or more PUCCH resource sets are configured via a 4-bit field (pucch-Resource Common) in RMSI or some other higher layer parameter. In some implementations, the PUCCH resource set includes 16 cell specific PUCCH resources. In some implementations, the MAC CE or the RAR in the MsgB includes a 3-bit PRI, and the technique includes determining the PUCCH resource based on the indicated PRI in the MsgB and a starting CCE index of the PDCCH scheduling the MsgB transmission by deriving the PUCCH resource index r_{PUCCH}.

In some implementations, transmitting feedback includes transmitting the feedback using a spatial filter or Tx beam for (re)transmission of PUSCH, which is scheduled by UL grant in MsgB, wherein the spatial filter or Tx beam is same as spatial filter or Tx beam used for the MsgA PRACH or MsgA PUSCH transmission. The technique can include, when different spatial filters are applied for the transmission of MsgA PRACH and PUSCH, applying the same spatial filter for MsgA PUSCH and PUSCH transmission which is scheduled by a MsgB UL grant. The technique can include transmitting the feedback using a spatial filter or Tx beam for transmitting of the PUCCH carrying HARQ feedback for the received MsgB, wherein the spatial filter or Tx beam is a same spatial filter or Tx beam that was used for the MsgA PRACH or MsgA PUSCH transmission. The technique can include transmitting the feedback using a spatial filter or Tx beam for the transmission of PUCCH carrying HARQ feedback corresponding to the MsgB, wherein the spatial filter or the Tx beam is configured by higher layer signaling.

In some implementations, the higher layer signaling includes a configuration, and the configuration indicates spatial relation information, wherein the higher layer signaling includes a MAC CE or RRC message(s). In some implementations, transmitting feedback includes, when the spatial relation information is not configured, transmitting the feedback using a spatial filter or Tx beam for transmitting the PUCCH carrying HARQ feedback for the received MsgB that is a same spatial filter or Tx beam that was used for the MsgA PRACH or MsgA PUSCH transmission.

The technique can include detecting the DCI format in response to a PUSCH transmission scheduled by a MsgB UL grant provided in the corresponding MsgB message, or a corresponding PUSCH retransmission scheduled by a DCI format 0_0 with CRC scrambled by a TC-RNTI provided in the corresponding MsgB message. The technique can include assuming that the PDCCH carrying the DCI format has the same DM-RS antenna port quasi co-location properties as a SS/PBCH block used for MsgA PRACH or MsgA PUSCH association regardless of whether or not a TCI-State for a CORESET is provided in the DCI. The technique can include transmitting the HARQ-NACK feedback on the PUCCH indicated by the DCI. The technique can include restarting a MsgB reception timer. The technique can include continuing to monitor for PDCCH addressed to the C-RNTI sent in the MsgA for a resource allocation of the PDSCH; and/or continuing or causing to continue to monitor for PDCCH addressed to the RA-RNTI or MsgB-RNTI for fallback to a 4-step RACH procedure during a subsequent MsgB reception duration.

The technique can include re-attempting the 2-step RACH procedure when the PDCCH addressed to C-RNTI or the PDCCH addressed to the RA-RNTI/MsgB-RNTI is not received upon expiry of a MsgB reception timer, wherein the re-attempting includes performing random access preamble and MsgA generation and transmission. The technique can include transmitting the HARQ-NACK feedback on the PUCCH indicated by the DCI. The technique can include continuing to monitor for PDCCH addressed to the C-RNTI included in the MsgA during an existing MsgB reception timer window; and upon expiration of the MsgB reception timer, re-attempting the 2-step RACH procedure when the PDCCH addressed to C-RNTI or the PDCCH addressed to the RA-RNTI/MsgB-RNTI is not received upon expiry of a MsgB reception timer. The re-attempting can include performing random access preamble and MsgA generation and transmission.

The technique can include declaring contention resolution successful and the random access procedure to be successfully completed when the PDCCH addressed to the C-RNTI sent in MsgA during the MsgB reception window is properly decoded and the DCI contains a UL grant. The technique can include, when the PDCCH addressed to the RA-RNTI or MsgB-RNTI is properly decoded and the allocated PDSCH is not properly decoded during the MsgB reception timer window, declaring no reception of the MsgB; and continuing to monitor for PDCCH addressed to the RA-RNTI or MsgB-RNTI until the end of the MsgB reception timer window; and upon expiry of the MsgB reception timer window, re-attempting the 2-step RACH procedure when the PDCCH addressed to C-RNTI or the PDCCH addressed to the RA-RNTI or MsgB-RNTI is not received upon expiry of a MsgB reception timer. The re-attempting can include performing random access preamble and MsgA generation and transmission.

The technique can include, when the PDCCH addressed to the RA-RNTI or MsgB-RNTI is properly decoded, the allocated PDSCH is properly decoded, and the PDSCH contains a UL grant for the HARQ feedback, stopping the MsgB reception timer; transmitting a PUSCH transmission with or without the HARQ feedback on a PUSCH; and considering the contention resolution successful and random access procedure to be successfully completed. The technique can include, when the PDCCH addressed to the RA-RNTI or MsgB-RNTI is properly decoded, the allocated PDSCH is properly decoded, and the PDSCH contains a PUCCH allocation index for the HARQ feedback, stopping the MsgB reception timer; and transmitting the HARQ feedback on the indicated PUCCH resource; and considering the contention resolution successful and random access procedure to be successfully completed.

Another techniques includes receiving, at a gNB, a MsgA from a UE during a 2-step RACH procedure, transmitting a MsgB to the UE in response to the MsgA; and receiving feedback indicating whether the UE successfully or unsuccessfully received and decoded the MsgB. The technique can include starting a MsgB receipt feedback timer, wherein the timer counts a time during which to receives the feedback. The technique can include declaring reception of the MsgB to have failed and/or an unsuccessful completion of the 2-step RACH procedure when the feedback is not received prior to expiration of the timer. The technique can include declaring a reception of the MsgB to be successful and/or successful completion of the 2-step RACH procedure when the feedback is received prior to expiration of the timer; and stopping the timer.

These and other techniques can be performed by an apparatus that is implemented in or employed by one or more types of network components, user devices, or both. In some implementations, one or more non-transitory computer-readable media comprising instructions to cause an electronic device, upon execution of the instructions by one or more processors of the electronic device, to perform one or more of the described techniques. An apparatus can include one or more processors and one or more computer-readable media comprising instructions that, when executed by the one or more processors, cause the one or more processors to perform one or more of the described techniques.

The methods described here may be implemented in software, hardware, or a combination thereof, in different implementations. In addition, the order of the blocks of the methods may be changed, and various elements may be added, reordered, combined, omitted, modified, and the like. Various modifications and changes may be made as would be obvious to a person skilled in the art having the benefit of this disclosure. The various implementations described here are meant to be illustrative and not limiting. Many variations, modifications, additions, and improvements are possible. Accordingly, plural instances may be provided for components described here as a single instance. Boundaries between various components, operations and data stores are somewhat arbitrary, and particular operations are illustrated in the context of specific illustrative configurations. Other allocations of functionality are envisioned and may fall within the scope of claims that follow. Finally, structures and functionality presented as discrete components in the example configurations may be implemented as a combined structure or component.

The methods described herein can be implemented in circuitry such as one or more of: integrated circuit, logic circuit, a processor (shared, dedicated, or group) and/or memory (shared, dedicated, or group), an Application Specific Integrated Circuit (ASIC), a field-programmable device (FPD) (e.g., a field-programmable gate array (FPGA), a programmable logic device (PLD), a complex PLD (CPLD), a high-capacity PLD (HCPLD), a structured ASIC, or a programmable SoC), digital signal processors (DSPs), or some combination thereof. Examples of processors can include Apple A-series processors, Intel® Architecture Core™ processors, ARM processors, AMD processors, and Qualcomm processors. Other types of processors are possible. In some implementations, the circuitry may execute one or more software or firmware programs to provide at least some of the described functionality. The term “circuitry” may also refer to a combination of one or more hardware elements (or a combination of circuits used in an electrical or electronic system) with the program code used to carry out the functionality of that program code. In these embodiments, the combination of hardware elements and program code may be referred to as a particular type of circuitry. Circuitry can also include radio circuitry such as a transmitter, receiver, or a transceiver.

A number of implementations have been described. Nevertheless, it will be understood that various modifications may be made. Elements of one or more implementations may be combined, deleted, modified, or supplemented to form further implementations. As yet another example, the logic flows depicted in the figures do not require the particular order shown, or sequential order, to achieve desirable results. In addition, other steps may be provided, or steps may be eliminated, from the described flows, and other components may be added to, or removed from, the described systems. Accordingly, other implementations are within the scope of the following claims.

1. A method comprising:
transmitting a first message of a two-step random access procedure to a node of a wireless communication network;
receiving, from the node in response to the first message, a second message of the two-step random access procedure via a physical downlink shared channel (PDSCH);
determining a physical uplink control channel (PUCCH) resource based on the second message; and
transmitting hybrid automatic repeat request—acknowledgement (HARQ-ACK) feedback for the second message on the determined PUCCH resource.

2. The method of claim 1, wherein the second message comprises an uplink grant field that indicates one or more resources, and wherein the determined PUCCH resource is based on the uplink grant field.

3-6. (canceled)

7. The method of claim 1, comprising:
receiving, for a user equipment (UE), a DCI message on a control resource set (CORESET); and
using a same demodulation reference signal (DM-RS) antenna port quasi co-location properties as for a synchronization signal (SS) physical broadcast channel (PBCH) block the UE used for a physical random access channel (PRACH) association regardless of whether or not the UE is provided a transmission configuration indicator (TCI) state for the CORESET.

8. The method of claim 1, comprising:
receiving information that provides a configuration of a PUCCH resource set,
wherein the second message includes a PUCCH resource indicator field that identifies a resource within the PUCCH resource set, wherein the determined PUCCH resource is based on the PUCCH resource indicator field.

9. (canceled)

10. The method of claim 1, wherein the second message includes a random access response (RAR) message, wherein the RAR message includes a PDSCH-to-HARQ feedback timing indicator field, and wherein transmitting the HARQ-ACK feedback comprises using a slot that is based on the PDSCH-to-HARQ feedback timing indicator field.

11. The method of claim 1, wherein transmitting the HARQ-ACK feedback comprises using a spatial domain transmission filter that was used in a last physical uplink shared channel (PUSCH) transmission from a user equipment for which the HARQ-ACK feedback was transmitted the UE.

12. An apparatus comprising:
a transceiver; and
one or more processors coupled with the transceiver, wherein the one or more processors are configured to perform operations comprising:
transmitting, via the transceiver, a first message of a two-step random access procedure to a node of a wireless communication network;
receiving, via the transceiver from the node in response to the first message, a second message of the two-step random access procedure via a physical downlink shared channel (PDSCH);
determining a physical uplink control channel (PUCCH) resource based on the second message; and
transmitting, via the transceiver, hybrid automatic repeat request-acknowledgement (HARQ-ACK) feedback for the second message on the determined PUCCH resource.

13. The apparatus of claim 12, wherein the second message comprises an uplink grant field that indicates one or more resources, and wherein the determined PUCCH resource is based on the uplink grant field.

14-17. (canceled)

18. The apparatus of claim 12, wherein the operations comprise:
receiving a DCI message on a control resource set (CORESET), and
using the same demodulation reference signal (DM-RS) antenna port quasi co-location properties as for a synchronization signal (SS) physical broadcast channel (PBCH) block a user equipment (UE) used for a physical random access channel (PRACH) association regardless of whether or not the UE is provided a transmission configuration indicator (TCI) state for the CORESET.

19. The apparatus of claim 12, wherein the operations comprise:
receiving information that provides a configuration of a PUCCH resource set,
wherein the second message includes a PUCCH resource indicator field that identifies a resource within the PUCCH resource set, wherein the determined PUCCH resource is based on the PUCCH resource indicator field.

20. The apparatus of claim 12, wherein the second message includes a HARQ feedback timing indicator.

21. The apparatus of claim 12, wherein the second message includes a random access response (RAR) message, wherein the RAR message includes a PDSCH-to-HARQ feedback timing indicator field, and wherein transmitting the HARQ-ACK feedback comprises using a slot that is based on the PDSCH-to-HARQ feedback timing indicator field.

22. The apparatus of claim 12, wherein transmitting the HARQ-ACK feedback comprises using a spatial domain transmission filter that was used in a last physical uplink shared channel (PUSCH) transmission from a user equipment (UE).

23. A system comprising:
a transceiver to communicate with a user equipment (UE); and
a processor coupled with the transceiver, wherein the processor is configured to perform operations comprising:
receiving, via the transceiver, a first message of a two-step random access procedure from the UE;
transmitting, via the transceiver, a second message of the two-step random access procedure on a physical downlink shared channel (PDSCH), wherein the second message provides information to the UE to determine PUCCH resources; and
receiving, via the transceiver, hybrid automatic repeat request-acknowledgement (HARQ-ACK) feedback for the second message from the UE in accordance with the PUCCH resources.

24. The system of claim 23, wherein the second message comprises an uplink grant field that indicates one or more PUCCH resources.

25-28. (canceled)

29. The system of claim 23, wherein the operations comprise transmitting a DCI message on a control resource set (CORESET), wherein transmitting the second message comprises transmitting the second message such that the UE uses the same demodulation reference signal (DM-RS) antenna port quasi co-location properties as for a synchronization signal (SS) physical broadcast channel (PBCH) block the UE used for a physical random access channel (PRACH) association regardless of whether or not the UE is provided a transmission configuration indicator (TCI) state for the CORESET.

30. The system of claim 23, wherein the operations comprise transmitting information that provides a configuration of a PUCCH resource set, and wherein the second message includes a PUCCH resource indicator field that identifies a resource within the PUCCH resource set.

31. The system of claim 23, wherein the second message includes a HARQ feedback timing indicator.

32. The system of claim 23, wherein the second message includes a random access response (RAR) message, wherein the RAR message includes a PDSCH-to-HARQ feedback timing indicator field, and wherein receiving the HARQ-ACK feedback comprises receiving the HARQ-ACK feedback in a slot that is based on the PDSCH-to-HARQ feedback timing indicator field.

33. The system of claim 23, wherein receiving the HARQ-ACK feedback comprises receiving the HARQ-ACK feedback that was transmitted by the UE using a spatial domain transmission filter, wherein the spatial domain transmission filter was used in a last physical uplink shared channel (PUSCH) transmission from the UE.
